(19) United States
(12) Patent Application Publication
(10) Pub. No.: US 2011/0076466 A1
(43) Pub. Date: Mar. 31, 2011

(54) TONER COMPOSITION FOR ELECTROSTATIC PHOTOGRAPHY, DEVELOPER FOR ELECTROSTATIC PHOTOGRAPHY, METHOD OF FORMING ELECTROSTATIC PHOTOGRAPHIC IMAGE, AND ELECTROSTATIC PHOTOGRAPHIC IMAGE

(75) Inventors: Hisashi OKAMURA, Kanagawa (JP); Kousaku YOSHIMURA, Kanagawa (JP); Takafumi HOSOKAWA, Kanagawa (JP)

(73) Assignee: FUJIFILM CORPORATION, Tokyo (JP)

(21) Appl. No.: 12/892,936

(22) Filed: Sep. 29, 2010

(30) Foreign Application Priority Data
Sep. 30, 2009 (JP) 2009-227928

(51) Int. Cl. B32B 3/10; G03G 9/08; G03G 13/20

(52) U.S. Cl. 428/195.1; 430/105; 430/124.1

(57) ABSTRACT

The present invention provides a toner composition for electrostatic photography, including a reactive compound A having a reactive group XA, and a reactive compound B having a reactive group XB that is capable of reacting with the reactive group XA and forming a bond, wherein the reactive compound B is capable of forming a three-dimensionally bonded structure by reacting with the reactive compound A, and wherein the toner composition includes the reactive compound A and the reactive compound B in a mutually isolated state.

Preferably, the reactive compounds respectively have two or more reaction sites, and any one of the compounds has three or more reaction sites.

### CROSS-REFERENCE TO RELATED APPLICATION

This application claims priority under 35 USC 119 from Japanese Patent Application No. 2009-227928 filed on Sep. 30, 2009, the disclosure of which is incorporated by reference herein.

### BACKGROUND OF THE INVENTION

1. Field of the Invention

The present invention relates to a toner composition for electrostatic photography used in the image formation utilizing electrostatic latent images or the like, a developer for electrostatic photography which contains the toner composition, a method of forming an electrostatic photographic image using the developer, and an electrostatic photographic image formed by the method.

2. Description of the Related Art

In an image forming apparatus of electrophotographic system, it is general that an image is formed by a charging step of charging the surface of a latent image carrier, an exposure step of exposing the surface of the latent image carrier and thereby forming a latent image, a development step of attaching toner to the electrostatic latent image and thereby forming a toner image, a transfer step of transferring the toner image to a transfer member, and a fixing step of fixing the toner image on the transfer member. However, the request in recent years for an immediacy enhancement in the image formation has led to suggestion of various low temperature-fixable toner compositions.

In order to enhance the low temperature fixability of a toner composition, it has been suggested to use, for example, a toner resin having a relatively low glass transition temperature. However, there is a problem that during the transfer step, offset is likely to occur, or a formed image is likely to be blocked.

For this reason, there has been suggested a technology of suppressing offset by allowing the toner particles to react as a result of heating or ultraviolet irradiation at the time of fixing and to thereby form a crosslinked structure. For example, a toner prepared by adsorbing an unsaturated metal salt encapsulated in microcapsules, to a toner containing an unsaturated polyester, has been proposed (see, for example, Japanese Patent Application Laid-Open (JP-A) No. 2006-65025). Furthermore, a toner containing a styrene/acrylate polymer and an ultraviolet-curable acrylate, which is capable of forming a crosslinked structure when irradiated with ultraviolet radiation, and thereby enhancing the image strength, has also be proposed (see, for example, JP-A No. 2005-182041).

According to these technologies, although the strength of the formed images is improved to some extent, since formation of the crosslinked structure in the former method is achieved by oxidative polymerization which makes use of the oxygen in air, there is still room for improvement from the viewpoint of enhancing the image strength in a short time or preventing blocking. Furthermore, since the latter method involves ultraviolet irradiation of a toner image containing a large amount of a colorant, it is difficult for the curing reaction to proceed to a deeper part of the image, and the method is unsatisfactory from the viewpoint of preventing the blocking of images.

### SUMMARY OF THE INVENTION

As a result of intensive studies, the inventors of the present invention have found that the problems described above can be addressed by incorporating two or more kinds of polyfunctional reactive components capable of forming multiple-site binding, in a mutually isolated state. Thus, the inventors completed the invention.

The present invention provides a toner composition for electrostatic photography, including (A) a reactive compound A having a reactive group XA, and (B) a reactive compound B having a reactive group XB that is capable of reacting with the reactive group XA and forming a bond, wherein the reactive compound B is capable of forming a three-dimensionally bonded structure by reacting with the reactive compound A, and wherein the toner composition includes the reactive compound A and the reactive compound B in a mutually isolated state.

### DETAILED DESCRIPTION OF THE INVENTION

Hereinafter, exemplary embodiments of the invention will be explained in detail. First, a toner composition for electrostatic photography of the invention will be described.

### Toner Composition for Electrostatic Photography

The toner composition for electrostatic photography of the invention contains (A) a reactive compound A having a reactive group XA (hereinafter, may be referred to as a compound (A)) and (B) a reactive compound B having a reactive group XB that is capable of reacting with the reactive group XA and forming a bond (hereinafter, may be referred to as a compound (B)), wherein the reactive compound B is capable of forming a three-dimensionally bonded structure by reacting with the reactive compound A, and wherein the toner composition contains the reactive compound A and the reactive compound B in a mutually isolated state.

According to the invention, the term “three-dimensionally bonded structure” refers to a state in which polyfunctional compounds mutually form bonds in a network form at multiple sites. Thus, a linearly bonded structure formed by monofunctional compounds or bifunctional compounds is not included in the “three-dimensionally bonded structure” as used herein. However, when linear structures formed by such bonding are bonded to one another at multiple sites and thereby form a bonded structure in a network form, the resulting structure is included in the “three-dimensionally bonded structure” as used according to the invention.

With Respect to Bonded Structure

The term “bonded” as used in the “three-dimensionally bonded structure” according to the invention, is not particularly limited if the reactive group XA in the compound (A) and the reactive group XB in the compound (B) react with each other and form bonds that are capable of mutually restricting mobility of the compound (A) molecule and the compound (B) molecule, and examples of such bond include ionic bond, hydrogen bond, covalent bond, coordination bond, hydrophobic bond, physical bond, and the like. Among them, ionic bond, hydrogen bond or covalent bond is preferred from the viewpoint of the strength and stability of the bonds, and covalent bonding is more preferred.

Upon considering the reaction sites required by the compound (A) and the compound (B) to form a “three-dimensionally bonded structure,” when the number of the reactive group XA carried by the (A) reactive compound A is designated as nA, and the number of reaction sites carried by the reactive group XA, that is, the number of the compound (B) molecules with which the reactive group XA may form bonds, is designated as mA; and when the number of the reactive group XB carried by the (B) reactive compound B is designated as nB, and the number of reaction sites carried by the reactive group XB, that is, the number of the compound (A) molecules with which the reactive group XB may form bonds, is designated as mB, nA, mA, nB and mB satisfy relationships represented by the following expressions:

(nA×mA)≧2,

(nB×mB)≧2, and

{At least one of (nA×mA) or (nB×mB)}≧3.

In other words, the compound (A) and the compound (B) respectively have two or more reaction sites, at which these compounds are able to react with other, and when at least one of the compound (A) or the compound (B) has three or more reaction sites, a three-dimensionally bonded structure is formed.

With Respect to (A) Reactive Compound A and (B) Reactive Compound B

The compound (A) and the compound (B) may be any low molecular weight compounds or macromolecular compounds, as long as the compounds respectively have two or more, or three or more, reactive sites at which the compounds react with each other.

First, the combination of the reactive group XA and the reactive group XB carried respectively by the compound (A) and the compound (B) will be explained. Since the reactive group XA and the reactive group XB are capable of forming bonds with each other, several combinations [(1) to (3)] that are appropriate for this purpose will be described. In these representative combinations, any of them may be the reactive group XA or may be the reactive group XB.

(1) Combination of Nucleophilic Group and Electrophilic Group

A preferred example of the combination of reactive groups that are capable of bonding may be a combination in which one of XA and XB is a nucleophilic group, and the other is an electrophilic group.

Examples of the nucleophilic group include an amino group, a mercapto group, a phenolic hydroxyl group, a hydroxyl group, an active methylene group, and a phenol group. Among them, an amino group, a mercapto group and the like are preferred.

Examples of the electrophilic group include a halide group linked to an alkyl group, an acid halide group, an active ester group, a cyclic acid anhydride, an epoxy group, an oxetane group, an ethyleneimine group, a maleimide group, a vinylsulfone group, an acrylamide group, an acryloyloxy group, an aldehyde group, an isocyanate group. Among them, an epoxy group, an oxetane group, an ethyleneimine group, a maleimide group, and a vinylsulfone group are preferred.

Preferred examples of the combination of the two groups include a combination of an amino group and an epoxy group or a vinylsulfone group, and a combination of a mercapto group and an epoxy group or a vinylsulfone group.

(2) Combination of Diene and Dienophile

Examples of the diene include 1,3-diene, a cyclopentadienyl group, a furfuryl group, and among them, a cyclopentadienyl group and a furfuryl group are preferred.

Examples of the dienophile include maleimide.

Preferred examples of the combination of the two compounds include a combination of a cyclopentadienyl group and maleimide, a combination of a furfuryl group and maleimide.

(3) Combination of Functional Groups Forming Hydrogen Bonding

An example of the combination is a combination of uracil and adenine.

When the compound (A) and the compound (B) are low molecular weight compounds, the compounds include, for example, a structure represented by the following formula.

(A) Reactive Compound A

(XA-R²—)ₙ—R¹ Formula (A-I)

In Formula (A-I), XA represents a reactive group; R¹ represents an n-valent organic linking group; R² represents a single bond or a divalent organic linking group; R² and XA, which are present in a number of n, may be the same or different from each other; and n represents an integer of 2 or greater.

(B) Reactive Compound B

(XB-R⁴—)ₙ—R³ Formula (B-I)

In Formula (B-I), XB represents a reactive group; R³ represents an n-valent organic linking group; R⁴ represents a single bond or a divalent organic linking group; R⁴ and XB, which are present in a number of n, may be the same or different from each other; and n represents an integer of 2 or greater.

In the formulas described above, it is preferable that the integer “n” for R¹ and the integer “n” for R³ are each independently 2 to 10. The n-valent organic linking group represented by R¹ or R³ includes an atom or atoms selected from the group consisting of from 1 to 100 carbon atoms, from 0 to 10 nitrogen atoms, from 0 to 50 oxygen atoms, from 1 to 200 hydrogen atoms, and from 0 to 20 sulfur atoms. These linking groups may be further substituted or unsubstituted.

Specific examples of the organic linking group represented by R¹ or R³ include the structural units shown below, or a group constituted by combining the structural units. The group may also form a cyclic structure).

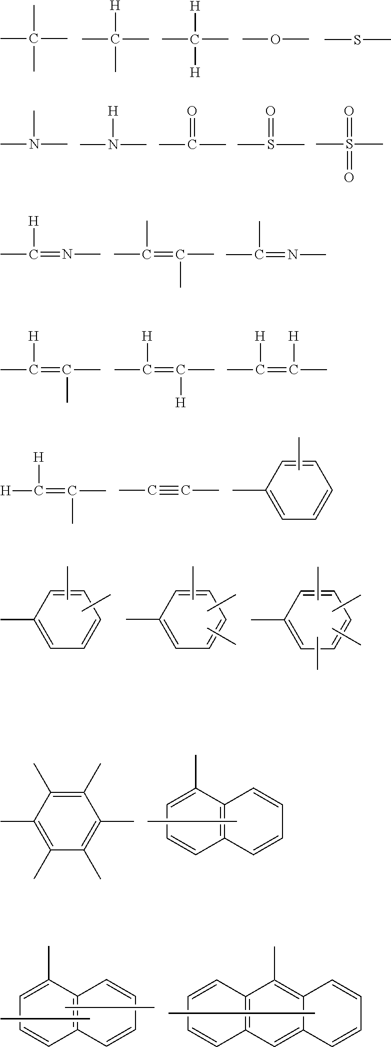

The organic linking group represented by R¹ or R³ is preferably an atom or atoms selected from the group consisting of from 1 to 60 carbon atoms, from 0 to 10 nitrogen atoms, from 0 to 40 oxygen atoms, from 1 to 120 hydrogen atoms, and from 0 to 10 sulfur atoms; more preferably an atom or atoms selected from the group consisting of from 1 to 50 carbon atoms, from 0 to 10 nitrogen atoms, from 0 to 30 oxygen atoms, from 1 to 100 hydrogen atoms, and from 0 to 7 sulfur atoms; and particularly preferably an atom or atoms selected from the group consisting of from 1 to 40 carbon atoms, from 0 to 8 nitrogen atoms, from 0 to 20 oxygen atoms, from 1 to 80 hydrogen atoms, and from 0 to 5 sulfur atoms.

Among them, if R¹ or R³ each have a substituent, examples of the substituent include an alkyl group having 1 to 20 carbon atoms such as a methyl group or an ethyl group; an aryl group having 6 to 16 carbon atoms such as a phenyl group or a naphthyl group; a hydroxyl group, an amino group, a carboxyl group, a sulfonamide group, an N-sulfonylamide group; an acyloxy group having 1 to 6 carbon atoms such as an acetoxy group; an alkoxy group having 1 to 6 carbon atoms such as a methoxy group or an ethoxy group; a halogen atom such as chlorine or bromine; an alkoxycarbonyl group having 2 to 7 carbon atoms such as a methoxycarbonyl group, an ethoxycarbonyl group or a cyclohexyloxycarbonyl group; a cyano group; a carbonic acid ester group such as t-butyl carbonate.

Specific examples of the n-valent organic linking group represented by R¹ or R³ [specific examples (1) to (17)] are shown below. However, the invention is not intended to be limited to these groups.

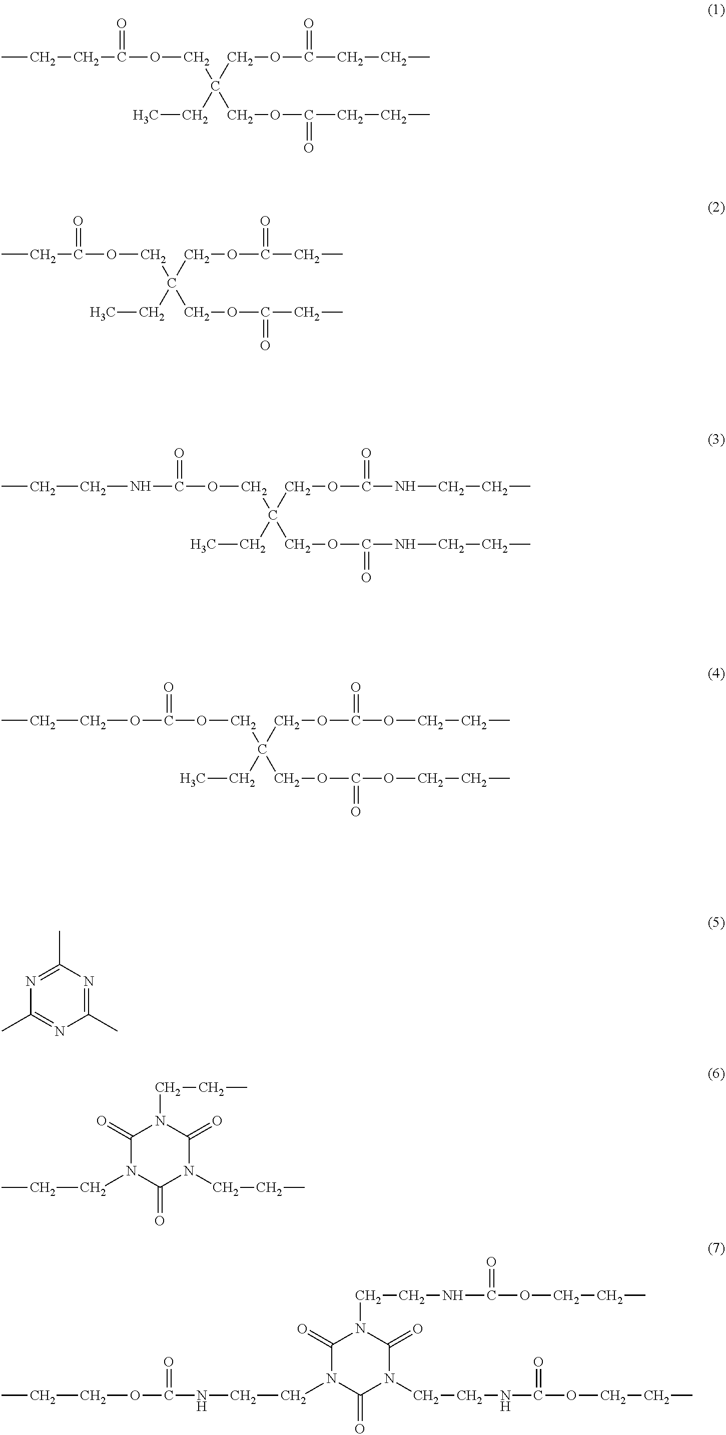

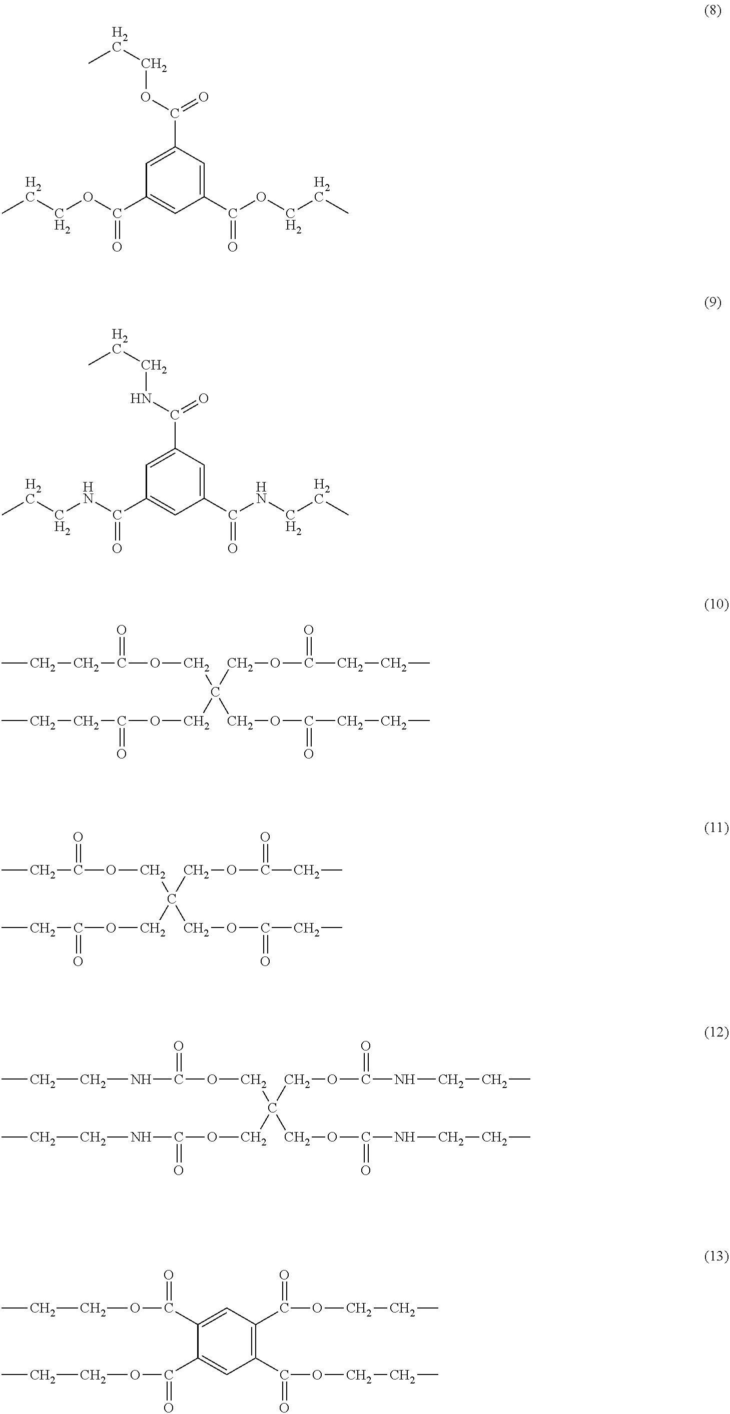

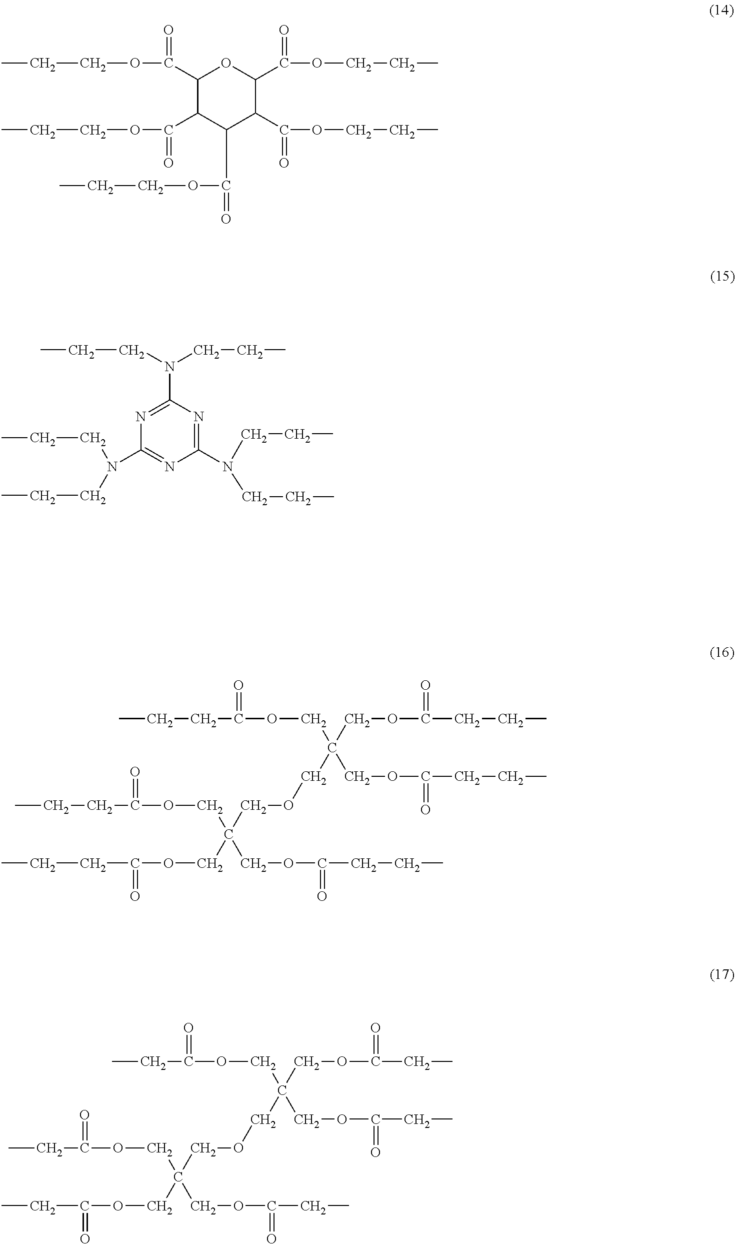

Among the specific examples described above, from the viewpoint of the availability of raw materials, ease of synthesis and solubility with respect to various solvents, the most preferred examples of the n-valent organic linking group are the following groups.

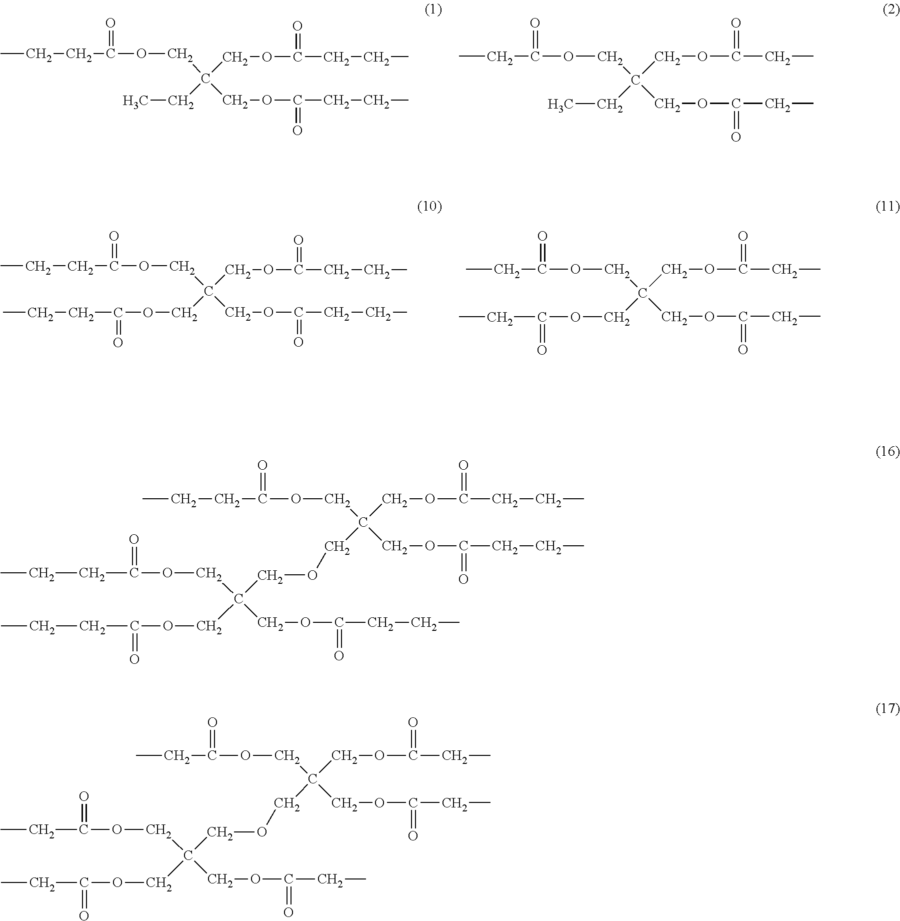

In Formula (A-I) and Formula (B-I), n represents 2 to 10. Preferably n is 2 to 8, more preferably 2 to 7, and particularly preferably 3 to 6.

R² and R⁴ each independently represent a single bond or a divalent organic linking group. A plurality (number of n) of R² may be the same or different from each other. Likewise, a plurality (number of n) of R⁴ may be the same or different from each other.

The divalent organic linking group includes an atom or atoms selected from the group consisting of from 1 to 100 carbon atoms, from 0 to 10 nitrogen atoms, from 0 to 50 oxygen atoms, from 1 to 200 hydrogen atoms, and from 0 to 20 sulfur atoms, and these groups may be further substituted or unsubstituted.

Specific examples of the divalent organic linking group include the structural units shown below, or groups constituted of combinations of the structural units.

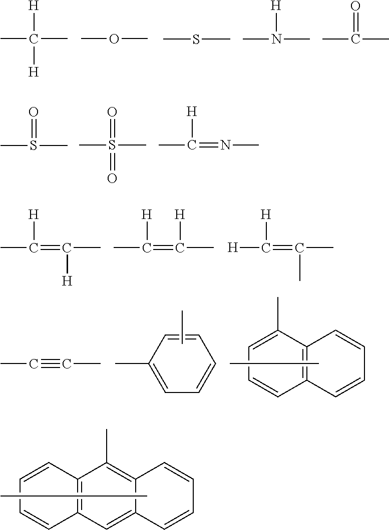

R² and R⁴ are preferably each independently a single bond, or a divalent organic linking group formed from 1 to 50 carbon atoms, from 0 to 8 nitrogen atoms, from 0 to 25 oxygen atoms, from 1 to 100 hydrogen atoms, or from 0 to 10 sulfur atoms, or a combination of these atoms; more preferably a single bond, or a divalent organic linking group formed from 1 to 30 carbon atoms, from 0 to 6 nitrogen atoms, from 0 to 15 oxygen atoms, from 1 to 50 hydrogen atoms, or from 0 to 7 sulfur atoms, or a combination of these atoms; and particularly preferably a single bond, or a divalent organic linking group formed from 1 to 10 carbon atoms, from 0 to 5 nitrogen atoms, from 0 to 10 oxygen atoms, from 1 to 30 hydrogen atoms, and from 0 to 5 sulfur atoms, or a combination of these atoms.

Among the groups described above, if the divalent organic linking group has a substituent, examples of the substituent include an alkyl group having 1 to 20 carbon atoms such as a methyl group or an ethyl group; an aryl group having 6 to 16 carbon atoms such as a phenyl group or a naphthyl group; a hydroxyl group, an amino group, a carboxyl group, a sulfonamide group, an N-sulfonylamide group; an acyloxy group having 1 to 6 carbon atoms such as an acetoxy group; an alkoxy group having 1 to 6 carbon atoms such as a methoxy group or an ethoxy group; a halogen atom such as chlorine or bromine; an alkoxycarbonyl group having 2 to 7 carbon atoms such as a methoxycarbonyl group, an ethoxycarbonyl group or a cyclohexyloxycarbonyl group; a cyano group; a carbonic acid ester group such as t-butyl carbonate.

Among these, R² and R⁴ are preferably each independently a single bond, an —S— group, an —O— group, a —COO— group, an —COO— group, a —CH₂— group, a —CH₂CH₂— group, a —C₆H₄— group, or a group constituted of a plurality of these groups in combination.

When the compound (A) or the compound (B) is low molecular weight compound, the molecular weight is preferably 500 to 8000, and more preferably 800 to 5000.

When the compound (A) or the compound (B) is a macromolecular compound, high density of multiple site bonds may be formed therein by introducing the reactive group XA or XB in a side chain of the structural unit contained in the macromolecular compound.

If one of the reactive compounds A and B is a macromolecular compound, the compound may be a homopolymer, but the compound is preferably a copolymer including, as components, a structural unit having a reactive group and a structural unit that does not have the reactive group, or a copolymer including, as components, structural units having different types of reactive groups.

When both the compound (A) and the compound (B) are macromolecular compounds, these compounds are respectively represented by, for example, the following formulas.

(A) Reactive Compound A: Macromolecular Compound

((XA-R²—)ₙ₋₁—R⁵—)ₚ—P Formula (A-II)

In Formula (A-II), XA represents a reactive group XA; R⁵ represents a single bond or an n-valent organic linking group; R² has the same definition as R² in the formula (A-I), and also has the same preferable definition as R² in Formula (A-I); P represents the main chain skeleton constructing the macromolecule; n represents an integer of 2 or greater; and p represents an integer of 2 or greater.

(B) Reactive Compound B: Macromolecular Compound

((XB-R⁴—)ₙ₋₁—R⁶—)ₚ—P Formula (B-II)

In Formula (B-II), XB represents a reactive group XB; R⁶ represents a single bond or an n-valent organic linking group; R⁴ has the same definition as R⁴ in Formula (B-I), and also has the same preferable definition as R⁴ in Formula (B-I); P represents the main chain skeleton constructing the macromolecule; n represents an integer of 2 or greater; and p represents an integer of 2 or greater.

In Formulas (A-II) and (B-II), R⁵ and R⁶ respectively have the same definitions as R¹ and R³ in the formulas (A-I) and (B-I), except that R⁵ and R⁶ may be single bonds, and also have the same preferable definitions as R¹ and R³ in Formulas (A-I) and (B-I).

Furthermore, n, R² and R⁴ respectively have the same definitions as n, R² and R⁴ in Formula (A-I) and Formula (B-I), and also have the same preferable definitions as n, R² and R⁴ in Formulas (A-I) and (B-I).

In Formula (A-II) and Formula (B-II), p represents from 2 to 1000. Preferably, p is from 5 to 500, more preferably from 10 to 300, and particularly preferably from 10 to 100.

In Formula (A-II) and Formula (B-II), P represents a main chain skeleton of the macromolecule, and may be selected from known polymers and the like in accordance with the purpose or the like. In regard to the main chain, it is preferable that the reactive groups XA and XB be respectively present in a side chain as shown in the formulas, from the viewpoint of reactivity. A partial structure including a reactive group may be introduced as a copolymerization component in a manner such that the partial structure including the reactive group is present within the structural unit contained in the macromolecular compound, or may be introduced by a polymeric reaction after formation of the main chain skeleton of the macromolecular compound.

Among the polymers, in order to construct a macromolecular main chain skeleton represented by P, it is preferable to use at least one selected from the group consisting of a polymer or a copolymer of a vinyl monomer, an ester-based polymer, an ether-based polymer, a urethane-based polymer, an amide-based polymer, an epoxy-based polymer, a silicone-based polymer, and modified products or copolymers thereof [including, for example, a polyether/polyurethane copolymer, and a copolymer of polyether/a polymer of a vinyl monomer (may be any of a random copolymer, a block copolymer and a graft copolymer)]. It is more preferable to use at least one selected from the group consisting of a polymer or a copolymer of a vinyl monomer, an ester-based polymer, an ether-based polymer, a urethane-based polymer, and modified products or copolymers thereof, and a polymer or a copolymer of a vinyl monomer is particularly preferred.

The polymer or copolymer of a vinyl monomer is explained below.

The vinyl monomer is not particularly limited, but for example, (meth)acrylic acid esters, crotonic acid esters, vinyl esters, maleic acid diesters, fumaric acid diesters, itaconic acid diesters, (meth)arylamides, styrenes, vinyl ethers, vinyl ketones, olefins, maleimides, (meth)acrylonitrile, nitrogen-containing vinyl monomers, vinyl monomers having acidic groups, and ionic vinyl monomers (anionic vinyl monomers and cationic vinyl monomers) are preferred.

Hereinafter, preferred examples of these vinyl monomers will be explained.

Examples of the (meth)acrylic acid esters include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, amyl (meth)acrylate, n-hexyl (meth)acrylate, cyclohexyl (meth)acrylate, 2-ethylhexyl (meth)acrylate, dodecyl (meth)acrylate, acetoxyethyl (meth)acrylate, 2-methoxyethyl (meth)acrylate, 2-ethoxyethyl (meth)acrylate, glycidyl (meth)acrylate, 3,4-epoxycyclohexylmethyl (meth)acrylate, benzyl (meth)acrylate, (meth)acrylic acid diethylene glycol monomethyl ether, (meth)acrylic acid diethylene glycol monoethyl ether, (meth)acrylic acid nonylphenoxy polyethylene glycol, trifluoroethyl (meth)acrylate, perfluorooctylethyl (meth)acrylate, and (meth)acrylic acid γ-butyrolactone.

Examples of the vinyl esters include vinyl acetate.

Examples of the (meth)acrylamides include (meth)acrylamide, N-methyl (meth)acrylamide, N-ethyl (meth)acrylamide, N-t-butyl (meth)acrylamide, N-cyclohexyl (meth)acrylamide, N,N-dimethyl (meth)acrylamide, N,N-diethyl (meth)acrylamide, N-phenyl (meth)acrylamide, N-ethyl-N-phenyl acrylamide, N-benzyl (meth)acrylamide, (meth)acryloylmorpholine, diacetone acrylamide, and N-methylol acrylamide.

Examples of the styrenes include styrene, methylstyrene, dimethylstyrene, trimethylstyrene, ethylstyrene, chloromethylstyrene, and methyl vinylbenzoate.

Examples of the vinyl ethers include methyl vinyl ether, and ethyl vinyl ether.

Examples of the olefins include ethylene, propylene, isobutylene, butadiene, and isoprene.

Examples of the maleimides include maleimide, butyl maleimide, cyclohexyl maleimide, and phenyl maleimide.

(Meth)acrylonitrile, a heterocycle substituted with a vinyl group (for example, vinylpyridine, N-vinylpyrrolidone, vinylcarbazole, N-vinylimidazole, and vinylcaprolactone), and the like may also be used.

When the compound (A) and the compound (B) are macromolecular compounds, their weight average molecular weight is preferably 1000 to 500,000, and more preferably 1200 to 100,000.

The weight average molecular weight of a macromolecular compound may be measured under the conditions as described below.

The weight average molecular weight may be determined by a gel permeation chromatographic method, using a GPC analyzer making use of three columns (all trade names: TSKGEL GMHxL, TSKGEL G4000 HxL and TSKGEL G2000HxL, all manufactured by Tosoh Corp.), by detecting the molecular weight using a differential refractometer in a tetrahydrofuran solvent and calculating the weight average molecular weight with respective to standard polystyrenes.

Preferred combinations [(1) to (24)] of the compound (A) and the compound (B) used in the toner composition of the invention will be presented below by showing specific combination examples of the compound (A) (A-i) and specific examples of the compound (B) (B-i), but the invention is not intended to be limited to these. Herein, i represent an integer of from 1 to 24.

In addition, the combinations presented below undergo a quick reaction upon fixing of the toner whereby a firm three-dimensionally bonded structure is formed. Therefore, the combinations are effective in enhancing the strength and anti-blocking properties of images formed by the toner composition.

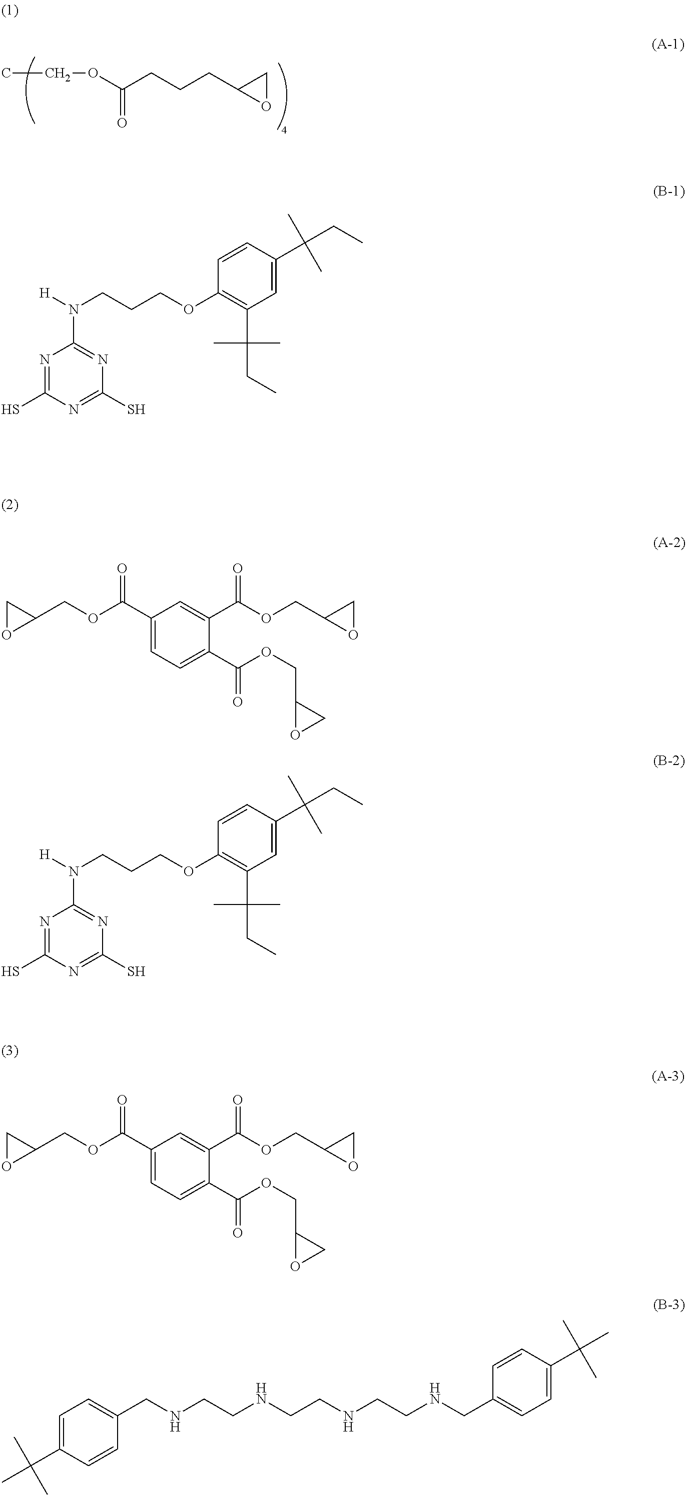

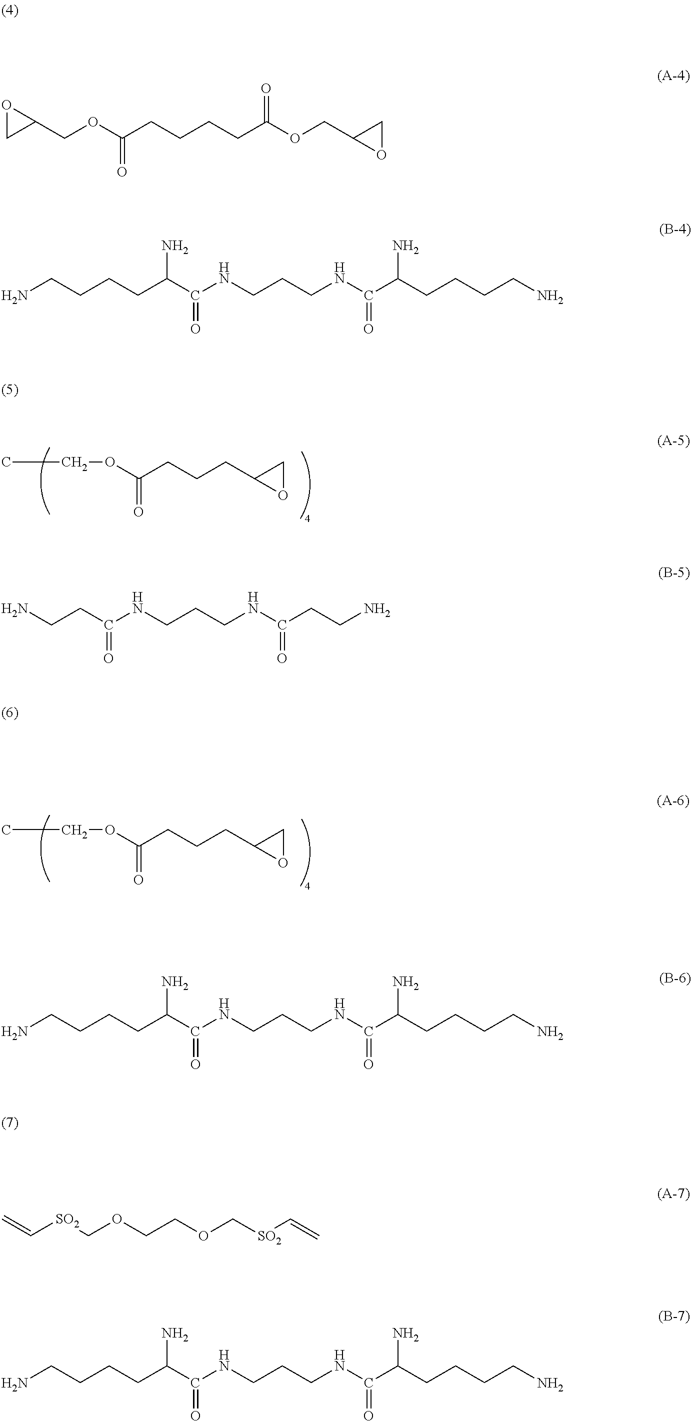

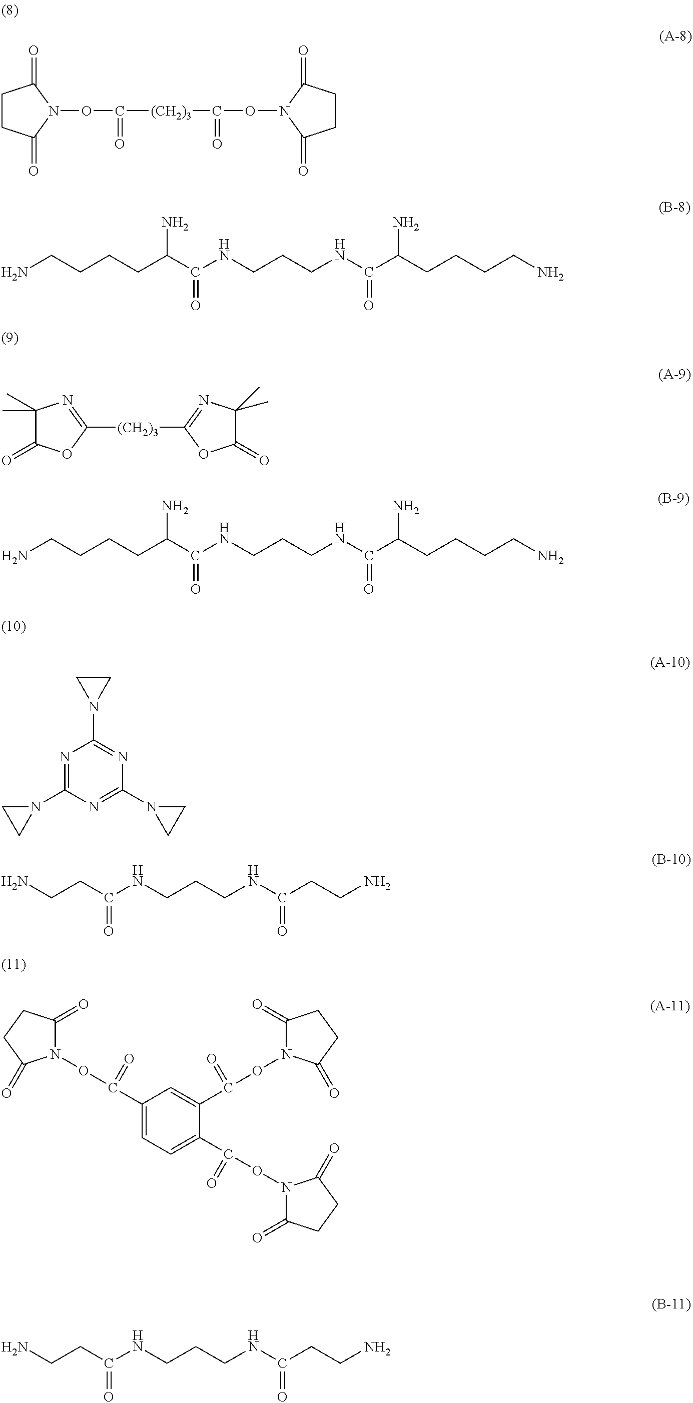

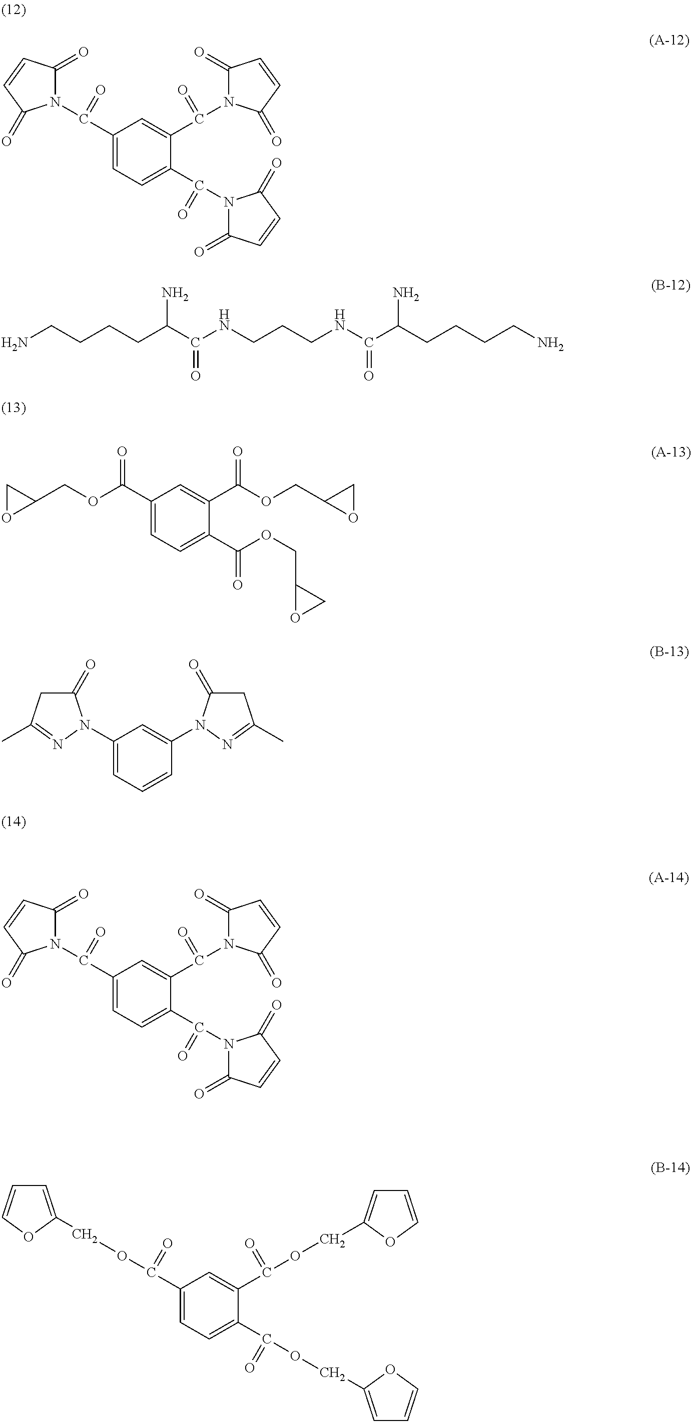

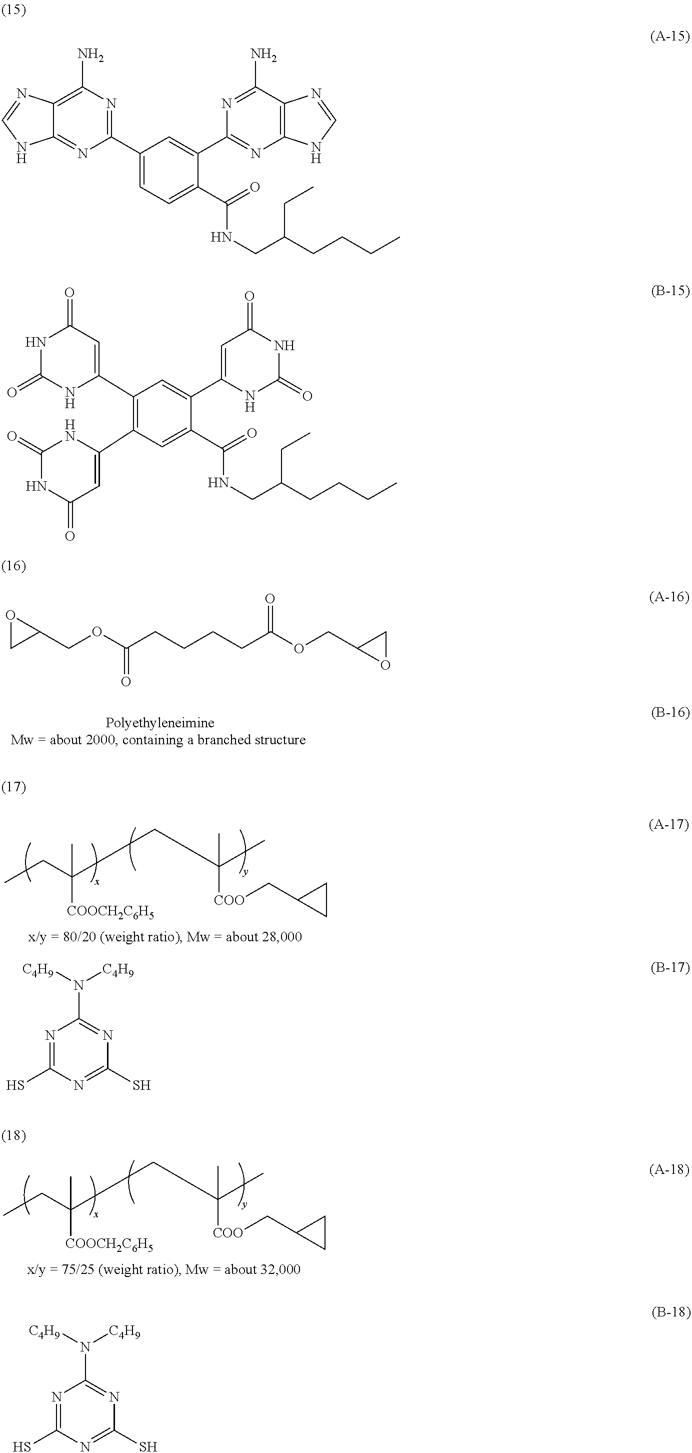

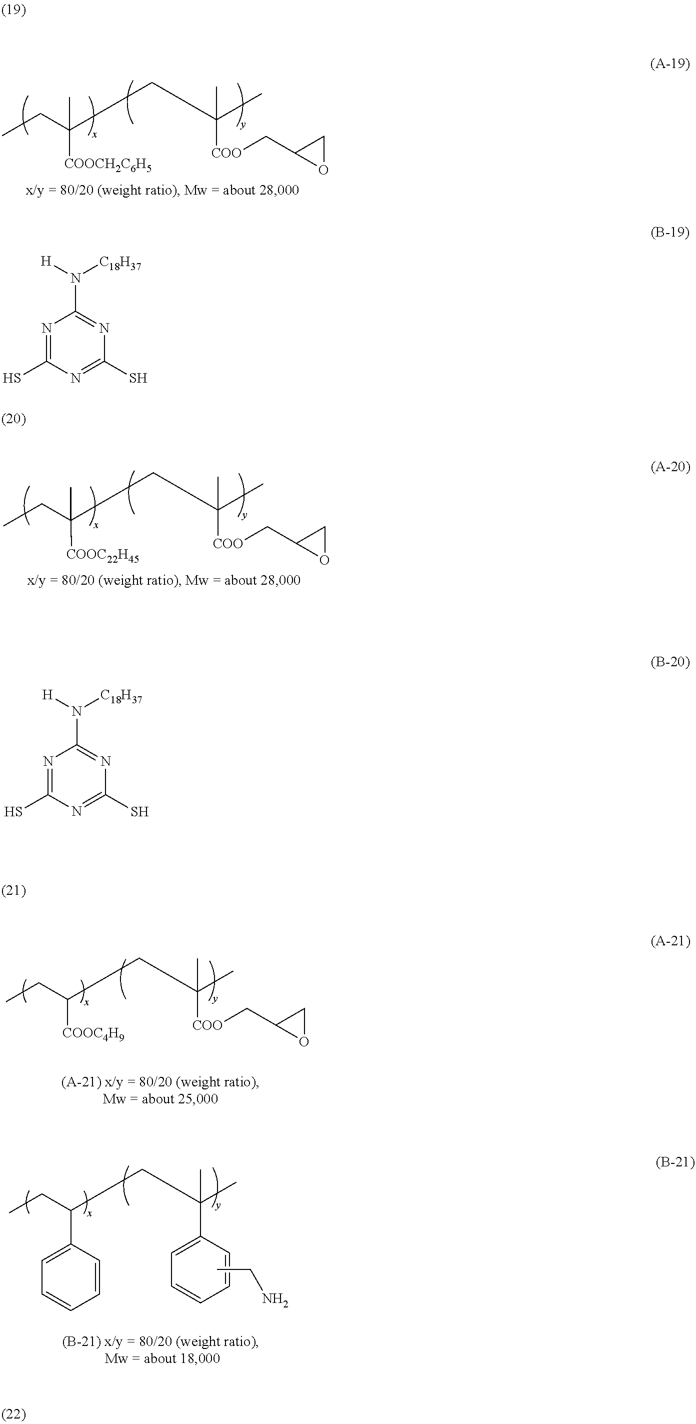

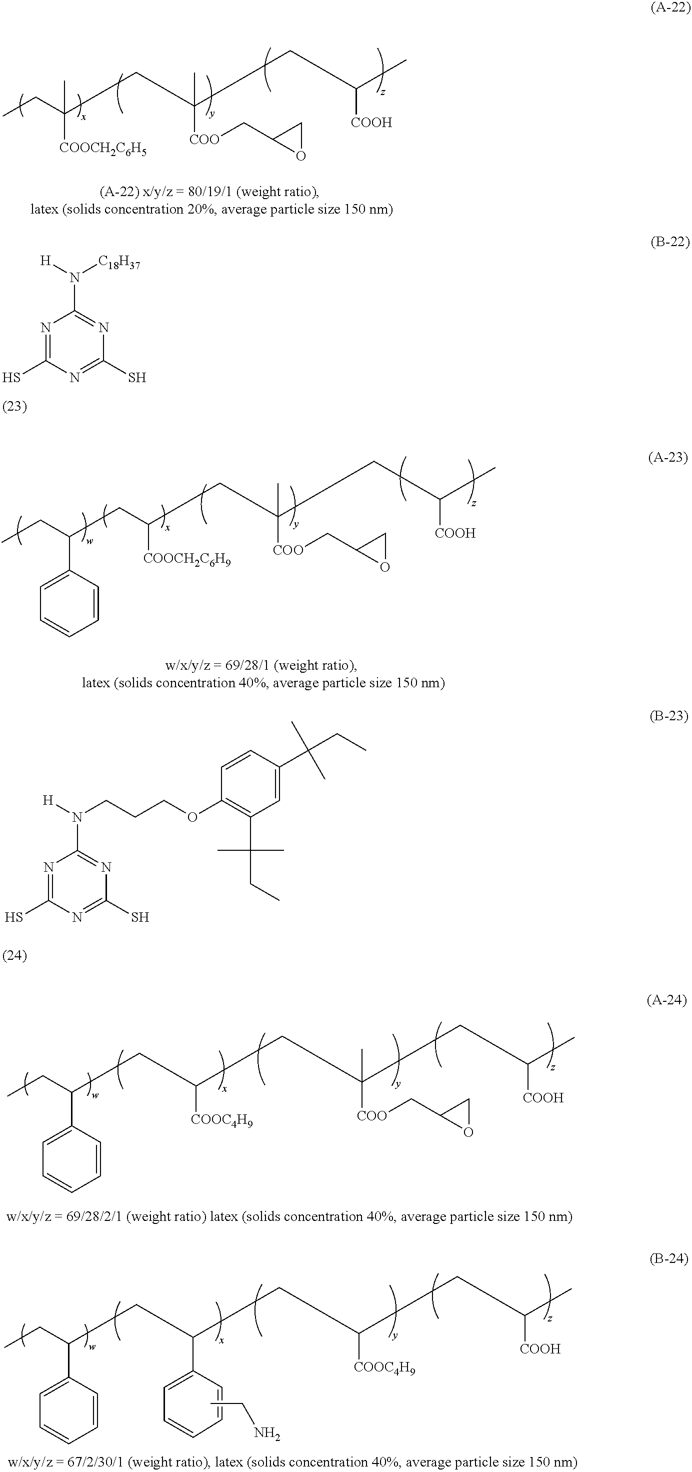

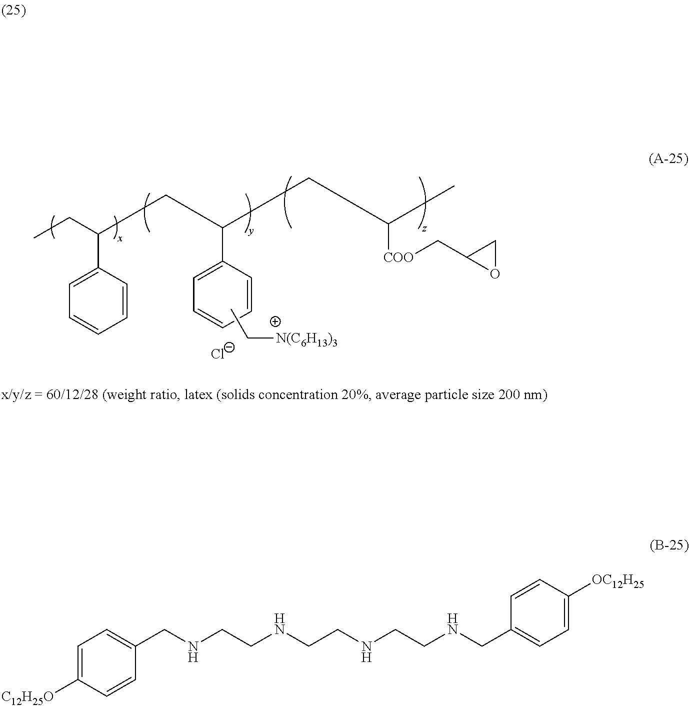

As described above, the combination of the compound (A) and the compound (B) may be any of a combination of low molecular weight compounds, a combination of macromolecular compounds, or a combination of a low molecular weight compound and a macromolecular compound, as long as the combination includes a compound having a reactive group XA and a compound having a reactive group XB, which may be bonded to each other.

The content ratio of the compound (A) and the compound (B) included in the toner components is selected according to the purpose, but in consideration of efficiency of forming bonds, it is preferable that the reactive group XA and the reactive group XB respectively included in the compounds are present in equimolar amounts or at a ratio close to the equimolar ratio.

Furthermore, the amount of the compound (A) included in the toner composition is preferably in the range of from 2% by mass to 30% by mass, and more preferably from 3% by mass to 20% by mass, with respect to a total solids content of the toner composition. The amount of the compound (B) is preferably in the range of 2% by mass to 30% by mass, and more preferably from 3% by mass to 20% by mass, with respect to a total solids content of the toner composition.

Next, other components of the toner composition of the invention are described.

A toner that is used in the toner composition of the invention is not particularly limited, and the toner may be a one-component toner or may be a two-component toner used in combination with a carrier. Furthermore, from the viewpoint of the production method, a kneaded and pulverized toner obtained by kneading, pulverizing and classifying a toner material; a polymerized toner obtained by suspension polymerization or emulsion polymerization using a reactive monomer having a vinyl group; a dissolved and suspended toner obtained by dissolving the binder resin and colorant mentioned below in an organic solvent and dispersing the solution in water to produce granules; or the like may be adequately used.

When the compound (A) and the compound (B) are respectively incorporated into different kinds of toner particles so that the compounds are contained in a mutually isolated state, the compounds are respectively incorporated into different kinds of toner particles, each of which contains the same or different colorants. In this case, the toner composition of the invention is constituted to include two kinds of toner particles.

Furthermore, when the compound (A) and the compound (B) are respectively incorporated into toner particles and external additive particles, one compound is incorporated into the toner particles containing a colorant, and another compound is incorporated into the external additive particles. In this case, the toner composition of the invention is constituted to include toner particles and external additive particles.

The resin constituting the toner particles is not particularly limited, and a known resin for toner particles may be selected and used according to the purpose. Examples of the resin include polystyrene, a styrene-propylene copolymer, a styrene-butadiene copolymer, a styrene-vinyl chloride copolymer, a styrene-vinyl acetate copolymer, a styrene-acrylic acid ester copolymer, a styrene-methacrylic acid ester copolymer, a crystalline or amorphous polyester resin, a polyurethane resin, and these resins are used singly or in combination of plural kinds as necessary.

When the compound (A) and the compound (B) according to the invention are macromolecular compounds, these macromolecular compounds may be used as the resins that form the toner particles.

The content of the resin in the toner particles is preferably in the range of from 2% by mass to 99% by mass, and more preferably from 5% by mass to 90% by mass, with respect to a total solid content that constitutes the toner particles.

The toner particles of the invention contain a colorant.

A pigment is used as the colorant, and the pigment is adequately selected based on the color of the toner particles. For example, carbon black, nigrosin, or graphite may be used as a black toner.

As a yellow toner, known yellow pigments or known orange pigments such as shown below may be used. Examples include C.I. Pigment Orange 31, C.I. Pigment Orange 43, C.I. Pigment Yellow 12, C.I. Pigment Yellow 14, C.I. Pigment Yellow 17, C.I. Pigment Yellow 93, C.I. Pigment Yellow 94, C.I. Pigment Yellow 138, and C.I. Pigment Yellow 174.

As a magenta toner, known magenta pigments or known red pigments may be used. Examples include C.I. Pigment Red 5, C.I. Pigment Red 48:1, C.I. Pigment Red 53:1, C.I. Pigment Red 57:1, C.I. Pigment Red 122, C.I. Pigment 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

As a cyan toner, known cyan pigments or known green pigments may be used. Examples include C.I. Pigment Green 7, C.I. Pigment Blue 15, C.I. Pigment Blue 15:2, C.I. Pigment Blue 15:3, and C.I. Pigment Blue 60.

The content of the colorant in the toner particles is preferably from 0.5% by weight to 20% by weight based on the toner. When the content is in this range, sufficient color developing properties and sharp image are obtained, and density unevenness of the image due to poor distribution of the colorant is suppressed.

The toner composition of the invention may also contain various known additives for the purpose of enhancing the properties or controlling the physicality, in addition to at least one of the compound (A) or the compound (B) (when these compounds are incorporated into different kinds of toner particles, these two compounds are separately incorporated in two kinds of toner particles), the toner resin used as necessary, and the colorant. Examples of the additives include a wax agent for enhancing mold releasability, a charge controlling agent, an external additive, as represented by inorganic or organic microparticles, which is incorporated into the resin in a dispersed state or attached to the resin surface so as to enhance fluidity, and these additives may be adequately used in combination.

It is preferable that the shape of the toner particles be spherical, from the viewpoint of enhancing transferability. The volume average particle size of the toner particles is preferably from 3 to 6 μm, and more preferably from 5 to 6 μm, from the viewpoint of obtaining satisfactory developing properties, transferability, and high quality images. The measurement of the volume average particle size of the toner may be carried out by a method described below.

The volume average particle size of the toner particles may be measured using a laser diffraction particle size distribution analyzer (trade name: LA920, manufactured by Horiba, Ltd.) or the like.

Next, external additives that may be used in the toner composition of the invention are explained.

At the surface of the toner particles according to the invention, inorganic microparticles such as silica, alumina, titanium dioxide or calcium carbonate and organic resin microparticles formed from a vinyl-based resin, or a binding resin such as polyester and silicone may be used as an external additive, after the surface of the toner has been dried in the same manner as in the case of generally used toners, for the purpose of imparting fluidity or enhancing cleaning properties.

It is preferable that these external additives be added to the toner particles while shearing the additives in a dry state.

The external additive may also be attached to the surface of the toner particles in water. In this case, if the external additive is inorganic microparticles, inorganic microparticles that may be used as a conventional external additive to be added to the toner surface, for example, silica, alumina, titania, calcium carbonate, magnesium carbonate or tricalcium phosphate, may be dispersed in water together with an ionic surfactant, a macromolecular acid or a macromolecular base, and then may be attached to the surface of the toner particles.

The volume average particle size of the external additive microparticles is preferably in the range of from 0.5% to 50%, and more preferably in the range of from 1% to 10%, of the volume average particle size of the toner particles. Furthermore, the volume average particle size of the external additive microparticles may be measured by the same method as that used for the volume average particle size of the toner particles.

(Addition of External Additive Particles)

As one of the means to incorporate the (A) reactive compound A and the (B) reactive compound B into the toner composition of the invention in a mutually isolated state, there is available a method of incorporating one of the compound (A) and the compound (B) into the toner particles and incorporating the other into the external additive particles. The method of adding one of the compounds into toner particles is as described above.

As the method of adding the compound (A) or the compound (B) into the external additive particles, if the compound to be used is a macromolecular compound, the organic resin microparticles may be prepared according to a known method using, as a main component, a necessary compound selected from the compound (A) and the compound (B) in the same manner as preparation of organic resin microparticles. If these compounds are low molecular weight compounds, the organic resin microparticles may be prepared together with the binding resin used in the preparation of toner particles, and the like.

The thus prepared external additive particles which contain any of the compound (A) and the compound (B), may be attached to the surface of the toner particles by the same method as the method of attaching the external additive particles described above to the surface of the toner particles.

It is preferable that the particle size of the external additive particles containing the compound (A) or the compound (B) be a similar size of the above-described external additive particles that are conventionally used.

The preferred content of the compound (A) or the compound (B) that is separately contained in the toner particles or the external additive particles is the same as those described above.

In regard to the aspect on the addition of the external additive, for example, if the compound (A) is incorporated into the toner particles, an aspect of using the external additive particles containing the compound (B) in a state of being attached to the surface of the toner particles may be mentioned. However, if the toner particles have external additive particles containing the compound (B) attached thereto, external additive particles containing the compound (A) may be further attached to the toner particles, so that the toner particles have plural kinds of external additive particles attached thereto.

Developer for Electrostatic Photography

The developer for electrostatic photography of the invention (hereinafter, may be referred to simply as “a developer”) may be a one-component developer formed from the toner particles, or may be a two-component developer containing a carrier as described below and the toner particles.

Carrier

The carrier used when the developer of the invention is a two-component developer is not particularly limited. However, a resin-coated carrier having, on a core material, a resin coating layer containing an electroconductive material dispersed therein is preferably used.

When a carrier having a resin coating layer is used, even in the case where a strong force is applied, if an electroconductive material is incorporated into the resin coating layer of the carrier in a dispersed state, maintenance of high image quality over a long time is consequently made possible without largely changing the volume intrinsic resistance of the carrier.

Examples of the core material of the carrier include magnetic metals such as iron, nickel and cobalt; magnetic oxides such as ferrite and magnetite; glass beads, and the like; however, in order to adjust the volume intrinsic resistance using a magnetic brush method, it is preferable that the core material be a magnetic material.

The average particle size of the core material is generally from 10 to 500 μm, and preferably from 30 to 100 μm.

Examples of the resin used in the resin coating layer include polyethylene, polypropylene, polystyrene, polyacrylonitrile, polyvinyl acetate, polyvinyl alcohol, polyvinyl butyral, polyvinyl chloride, polyvinyl carbazole, polyvinyl ether, polyvinyl ketone, a vinyl chloride-vinyl acetate copolymer, a styrene-acrylic acid copolymer, a straight silicone resin having organosiloxane bonds or modification products thereof, a fluororesin, polyester, polyurethane, polycarbonate, a phenolic resin, an amino resin, a melamine resin, a benzoguanamine resin, a urea resin, an amide resin, an epoxy resin, and the like, but the examples are not intended to be limited to these resins.

Examples of the electroconductive material that may be contained in the resin coating layer include metals such as gold, silver and copper; titanium oxide, zinc oxide, barium sulfate, aluminum borate, potassium titanate, tin oxide, carbon black, but the examples are not intended to be limited to these materials.

The content of the electroconductive material is preferably from 1 to 50 parts by mass, and more preferably from 3 to 20 parts by mass, with respect to 100 parts by mass of the resin that constitutes the resin coating layer.

The average film thickness of the resin coating layer is usually preferably from 0.1 to 10 μm, and more preferably from 0.5 to 3 μm.

The content ratio of the toner and the carrier contained in the developer of the invention is preferably in the range of from 2:98 to 15:85, and more preferable from 3:97 to 10:90.

Method for Forming Electrostatic Photographic Image Using Developer for Electrostatic Photography

The method for forming an electrostatic photographic image of the invention includes (1) a latent image forming step of exposing the surface of a charged latent image carrier and thereby forming an electrostatic latent image; (2) a developing step of attaching the developer for electrostatic photography of the invention to the electrostatic latent image and thereby forming an image; and (3) a fixing step of heating and fixing the formed image to a recording medium.

In this (3) fixing step, the compound (A) and the compound (B), which are contained in a mutually isolated state, are brought into contact, and the reactive group XA and the reactive group XB included in the two compounds react with each other for the first time in this step and form a high-density three-dimensionally bonded structure in a network form. Thus, the strength and anti-blocking properties of the image formed by fixing are enhanced.

Here, the confirmation of whether such a three-dimensionally bonded structure have been formed, may be performed by dissolving a fixed toner image in an appropriate organic solvent (good solvent for the toner resin), and then removing the pigment component by centrifugation, and then observing the remaining part by visual inspection to see if a gel-like component is contained as a suspended matter. With respect to a fixed toner image that has formed a bonded structure, generation of a gel-like component is recognized. In contrast, with respect to a fixed toner image that has not formed a bonded structure, any solids such as a gel-like component are not recognized in the areas where the pigment has been excluded, and they has dissolved out.

For the image forming apparatus used in the image forming method of the invention, a known image forming apparatus for electrostatic photography may be appropriately used. However, from the viewpoint of bringing into contact the compound (A) and the compound (B) that are present in a mutually isolated state, and forming a bonded structure efficiently by means of the reactive group XA and the reactive group XB included in these compounds, it is preferable that the heating temperature at the time of fixing be from 120° C. to 180° C.

Electrostatic Photographic Image

An electrostatic photographic image formed by the image forming method for electrostatic photography of the invention using the toner composition of the invention, has a high-density three-dimensionally crosslinked structure formed within the image by heating at the time of fixation, and therefore, an image which shows satisfactory offset resistance and fixability, and exhibits excellent anti-blocking properties and high strength is formed immediately after fixing. Thus, the image may be applied to various applications.

The following is a list of exemplified aspects of the invention.

<1> A toner composition for electrostatic photography, containing a reactive compound A having a reactive group XA, and a reactive compound B having a reactive group XB that is capable of reacting with the reactive group XA and forming a bond, wherein the (B) reactive compound B is capable of forming a three-dimensionally bonded structure by reacting with the reactive compound A, and wherein the toner composition contains the reactive compound A and the reactive compound B in a mutually isolated state.
<2> The toner composition for electrostatic photography according to item <1>, including first toner particles containing the reactive compound A, and second toner particles containing the reactive compound B.
<3> The toner composition for electrostatic photography according to item <1>, including toner particles containing one of the reactive compound A or thereactive compound B, and external additive particles containing the other of the reactive compound A or thereactive compound B that is not present in the toner particles, in a state in which the external additive particles are attached to the surface of the toner particles.
<4> The toner composition for electrostatic photography according to any one of items <1> to <3>, wherein when the number of the reactive group XA included in the reactive compound A is designated as nA, and the number of reactive sites the reactive group XA as mA, and when the number of the reactive group XB included in the reactive compound B is designated as nB, and the number of reactive sites carried by the reactive group XB is designated as mB, nA, mA, nB and mB satisfy relationships represented by the following expressions:

(nA×mA)≧2,

(nB×mB)≧2, and

{at least any one of (nA(mA) or (nB(mB)}≧3.

<5> The toner composition for electrostatic photography according to any one of items <1> to <4>, wherein the reactive group XA is a nucleophilic group, and the reactive group XB is an electrophilic group.
<6> A developer for electrostatic photography, including the toner composition according to any one of items <1> to <5>.
<7> A method for forming an electrostatic photographic image, the method including a latent image forming step of exposing the surface of a charged latent image carrier and thereby forming an electrostatic latent image; a developing step of attaching the developer for electrostatic photography according to item <6> to the electrostatic latent image and thereby forming an image; and a fixing step of fixing by heating the formed image to a recording medium.
<8> An electrostatic photographic image, the image being a matter produced with the developer for electrostatic photography according to item <6>.

According to the invention, there may be provided a toner composition for electrostatic photography which shows satisfactory low temperature fixability and forms images that are excellent in the strength and anti-blocking properties, and a developer for electrostatic photography.

According to the invention, there may be provided a method for forming an electrostatic photographic image, which uses the developer for electrostatic photography and forms images showing high strength and excellent anti-blocking properties, and an electrostatic photographic image obtainable by the method.

### EXAMPLES

Hereinafter, the present invention is specifically explained with reference to Examples, but the invention is not intended to be limited to these Examples.

### Comparative Example 1

### 1. Preparation of Developer for Electrostatic Photography 1

1-1-1. Synthesis of Binding Resin 1

A bisphenol A-propylene oxide 2-mole adduct (1050 g), fumaric acid (355 g), hydroquinone (1 g), and dibutyltin oxide (1.4 g) were allowed to react for 5 hours at 210° C. and at normal pressure in a nitrogen atmosphere, and then were further allowed to react at 210° C. under reduced pressure, and thus a binding resin 1 was obtained. The obtained resin had a softening point of 102° C., an acid value of 20 mg KOH/g, and a glass transition temperature of 58° C.

1-1-2. Synthesis of Binding Resin 2

A bisphenol A-propylene oxide 2-mole adduct (830 g), a bisphenol A-ethylene oxide 2-mole adduct (320 g), terephthalic acid (350 g), dodecenyl succinic anhydride (45 g), trimellitic anhydride (140 g), and dibutyltin oxide (4 g) were allowed to react for 8 hours at 230° C. and at normal pressure in a nitrogen atmosphere, and then were further allowed to react under reduced pressure, and thus a binding resin 2 was obtained. The obtained resin had a softening point of 153° C., an acid value of 22 mg KOH/g, and a glass transition temperature of 72° C.

1-2. Preparation of Toner Particles 1

The binding resin 1 obtained in the Synthesis Example (60 parts by weight), the binding resin 2 obtained in the Synthesis Example (40 parts by weight), and a cyan pigment (product name: Pigment Blue 15:3, manufactured by Dainippon Ink & Chemicals, Inc.) (10 parts by weight) as a colorant were melt kneaded at 100° C. for 15 minutes in a kneading machine for laboratory use. The kneading product was micropulverized with a jet mill and classified with an air-stream classifier, and thus a powder having a volume average particle size of 8.0 μm was obtained.

In order to enhance the fluidity of toner masses, the obtained powder was mixed with 0.6% of hydrophobic colloidal silica particles (BET value 130 m2/g), and thus toner particles 1 were obtained.

1-3. Preparation of Developer for Electrostatic Photography 1

The obtained toner particles 1 (5 parts by weight) and silicon-coated Cu—Zn ferrite carrier particles having an average diameter of 55 μm (95 parts by weight) were mixed, and thus a developer for electrostatic photography 1 of Comparative Example 1 containing an external additive and toner particles was prepared.

### Comparative Example 2

### 2. Preparation of Developer for Electrostatic Photography 2

2-1. Preparation of Toner Particles 2A

The same binding resin 1 (60 parts by weight) and binding resin 2 (40 parts by weight) as those used in Comparative Example 1, a cyan pigment (Pigment Blue 15:3, manufactured by Dainippon Ink & Chemicals, Inc.) (10 parts by weight) as a colorant, and a monofunctional compound for comparison (A-C1) shown below (10 parts by weight) were melt kneaded at 100° C. for 15 minutes with a kneading machine for laboratory use. The kneading product was micropulverized with a jet mill and classified with an air-stream classifier, and thus a powder having a volume average particle size of 8.0 μm was obtained. As it is obvious from the structure shown below, the monofunctional compound for comparison (A-C1) is a Comparative Example compound having only one functional group corresponding to the reactive group XA (epoxy ring) in the molecule, and having one reaction site.

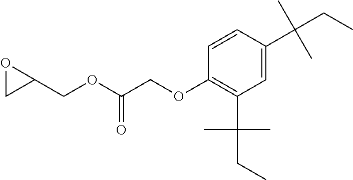

### Monofunctional Compound for Comparison (A-C1)

In order to enhance the fluidity of toner masses, the obtained powder and 0.6% hydrophobic colloidal silica particles (BET value 130 m²/g) were mixed, and thus toner particles for electrostatic photography 2A were obtained.

2-2. Preparation of Toner Particles 2B

Toner particles 2B were obtained exactly in the same manner as in the preparation of the toner particles 2A, except that a monofunctional compound for comparison (B-C1) (10 parts by weight) was used instead of the monofunctional compound for comparison (A-C1) used for the preparation of the toner particles 2A. The monofunctional compound for comparison (B-C1) is a Comparative Example compound having one functional group corresponding to the reactive group XB (amino group) in the molecule and having two reaction sites.

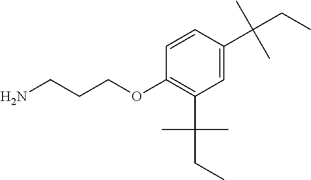

### Monofunctional Compound for Comparison (B-C1)

2-3. Preparation of Developer 2

2.5 parts by weight of the obtained toner particles 2A, 2.5 parts by weight of the toner particles 2B, and silicon-coated Cu—Zn ferrite carrier particles having an average diameter of 55 μm were mixed, and thus a developer for electrostatic photography 2 of Comparative Example 2 containing an external additive and toner particles was prepared.

### Comparative Example 3

### 3. Preparation of Developer for Electrostatic Photography 3

### Comparative Example: Case where the Reactive Compound does not Form a Network Structure Even if the Compound Reacts Bifunctionally

3-1. Preparation of Toner Particles 3A and Toner Particles 3B

Toner particles 3A and toner particles 3B were prepared in the same manner as in Comparative Example 2, except that a bifunctional compound for comparison (A-C2) and a bifunctional compound for comparison (B-C2) having the structures shown below were used instead of the monofunctional compound for comparison (A-C1) and the monofunctional compound for comparison (B-C1) used respectively in the toner particles 2A and the toner particles 2B in Comparative Example 2. As it is obvious from the structures shown below, the bifunctional compound for comparison (A-C2) is a Comparative Example compound having two functional groups corresponding to the reactive group XB (epoxy rings) in the molecule and having two reaction sites, while the bifunctional compound for comparison (B-C2) is a Comparative Example compound having two functional groups corresponding to the reactive group XB (amino groups) in the molecule and having two reaction sites.

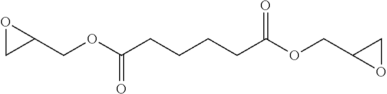

Bifunctional Compound for Comparison (A-C2)

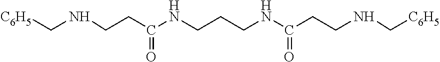

Bifunctional Compound for Comparison (B-C2)

3-2. Preparation of Developer for Electrostatic Photography 3

2.5 parts by weight of the obtained toner particles 3A, 2.5 parts by weight of the toner particles 3B, and silicon-coated Cu—Zn ferrite carrier particles having an average diameter of 55 μm were mixed, and thus a developer for electrostatic photography 3 of Comparative Example 3 containing an external additive and toner particles was prepared.

### Reference Example

### 4. Attempt for Preparation of Developing Agent for Electrostatic Photography 4

The (A) reactive compound (A-1) (5 parts by weight) and the (B) reactive compound (B-1) (5 parts by weight) according to the invention as described above were added to a mixture of the binding resin 1 (60 parts by weight) and the binding resin 2 (40 parts by weight) used in the Comparative Example 1, and a cyan pigment (trade name: Pigment Blue 15:3, manufactured by Dainippon Ink & Chemicals, Inc.) as a colorant. The mixture was melt kneaded at 100° C. with a kneading machine for laboratory use, but during kneading, the (A) compound (A-1) reacted with the (B) compound (B-1) so that a bonded structure was formed and the system cured. Normal toner particles were not obtained from this cured product.

### Example 1 to Example 21

### 5. Preparation of Developer for Electrostatic Photography 5 to Developer for Electrostatic Photography 25

Toner particles 5A to toner particles 25A and toner particles 5B to toner particles 25B were respectively prepared exactly in the same manner as in the preparation of the toner particles 2A and the toner particles 2B, except that (A) example compounds (A-1) to (A-21) and (B) example compounds (B-1) to (B-21) shown in Table 1 below were used instead of the bifunctional compound for comparison (A-C2) and the bifunctional compound for comparison (B-C2) used in the preparation of the toner particles 2A and the toner particles 2B, which were used in the preparation of the developer for electrostatic photography 2 of the Comparative Example 2.

Furthermore, developers for electrostatic photography 5 to 25 were prepared in the same manner as in the preparation of the developer for electrostatic photography 2 using these toner particles.

TABLE 1

| | | Toner particles used (A-i*) | | | Toner particles used (B-i*) | | |
|---|---|---|---|---|---|---|---|
| | | | Compound used | | | Compound used | |
| | | | | Amount | | | Amount |
| | | Toner | | of use | Toner | | of use |
| | Developer | particle | Example | (parts by | particle | Example | (parts by |
| | No. | No. | compound | weight) | No. | compound | weight) |
| Example 1 | 5 | 5A | A-1 | 10 | 5B | B-1 | 10 |
| Example 2 | 6 | 6A | A-2 | 10 | 6B | B-2 | 10 |
| Example 3 | 7 | 7A | A-3 | 10 | 7B | B-3 | 10 |
| Example 4 | 8 | 8A | A-4 | 10 | 8B | B-4 | 10 |
| Example 5 | 9 | 9A | A-5 | 10 | 9B | B-5 | 10 |
| Example 6 | 10 | 10A | A-6 | 7 | 10B | B-6 | 8 |
| Example 7 | 11 | 11A | A-7 | 5 | 11B | B-7 | 5 |
| Example 8 | 12 | 12A | A-8 | 8 | 12B | B-8 | 8 |
| Example 9 | 13 | 13A | A-9 | 15 | 13B | B-9 | 10 |
| Example 10 | 14 | 14A | A-10 | 10 | 14B | B-10 | 10 |
| Example 11 | 15 | 15A | A-11 | 10 | 15B | B-11 | 10 |
| Example 12 | 16 | 16A | A-12 | 12 | 16B | B-12 | 10 |
| Example 13 | 17 | 17A | A-13 | 15 | 17B | B-13 | 18 |
| Example 14 | 18 | 18A | A-14 | 15 | 18B | B-14 | 15 |
| Example 15 | 19 | 19A | A-15 | 15 | 19B | B-15 | 15 |
| Example 16 | 20 | 20A | A-16 | 12 | 20B | B-16 | 8 |
| Example 17 | 21 | 21A | A-17 | 12 | 21B | B-17 | 8 |
| Example 18 | 22 | 22A | A-18 | 12 | 22B | B-18 | 10 |
| Example 19 | 23 | 23A | A-19 | 12 | 23B | B-19 | 10 |
| Example 20 | 24 | 24A | A-20 | 10 | 24B | B-20 | 10 |
| Example 21 | 25 | 25A | A-21 | 15 | 25B | B-21 | 15 |

*i represents an integer of from 1 to 21.

### Example 22

### 6. Preparation of Developer 26

6-1. Preparation of Binder Resin Microparticle Dispersion Liquid 3

A monomer solution A was prepared by mixing and dissolving styrene (460 parts by weight), n-butyl acrylate (140 parts by weight), acrylic acid (12 parts by weight), and dodecanethiol (12 parts by weight). An anionic surfactant (trade name: DOWFAX, manufactured by Dow Chemical Company) (12 parts by weight) was dissolved in ion-exchanged water (250 parts by weight), and the monomer solution A was added to this resulting solution to obtain a dispersed and emulsified solution (monomer emulsion A) in a flask.

Subsequently, an anionic surfactant (trade name: DOWFAX, manufactured by Dow Chemical Company) (1 part by weight) was dissolved in ion-exchanged water (555 parts by weight), and the solution was fed to a flask for polymerization. Subsequently, the flask for polymerization was stoppered and sealed, a reflux tube was installed, and while injecting nitrogen thereto, and the system was slowly stirred, the flask for polymerization was heated in a water bath up to 75° C. and was maintained at the temperature. While maintaining in this state, a solution prepared by dissolving ammonium persulfate (9 parts by weight) in ion-exchanged water (43 parts by weight) was added dropwise to the flask for polymerization through a quantitative pump over 20 minutes, and then the monomer emulsion A was added dropwise thereto through a quantitative pump over 200 minutes. After completion of the dropwise addition, the flask for polymerization was maintained at 75° C. for 3 hours while slowly stirring, and thus polymerization was completed. Thus, binding resin microparticle dispersion liquid 3 having a solids content of 42% was obtained. The binding resin microparticles included in this dispersion liquid 3 had a median diameter of 200 nm, a glass transition temperature of 52° C., and a weight average molecular weight of about 24,000.

6-2. Preparation of (B) Reactive Compound (B-22) Dispersion Liquid

The (B) example compound (B-22) (50 parts by weight), an anionic surfactant (trade name: DOWFAX, manufactured by Dow Chemicals Company) (5 parts by weight), and ion-exchanged water (200 parts by weight) were heated to 90° C., and the mixture was sufficiently dispersed with a homogenizer (trade name: ULTRA-TURRAX T50, manufactured by IKA-Werke GmbH & Co. KG.) and then was subjected to a dispersion treatment with a pressure ejection type homogenizer (trade name: GORIN HOMOGENIZER, manufactured by Gorin, Inc.). Thus, a dispersion liquid of B-22 having a median diameter of 160 nm and a solids content of 21% was obtained.

6-2. Preparation of Variety of Other Dispersion Liquids

A colorant particle dispersion liquid (1) and a releasing agent particle dispersion liquid (1) were prepared according to the descriptions of JP-A No. 2004-163854.

6-3. Preparation of Toner Particles 26A

Aggregation Process

The binding resin microparticle dispersion liquid 3 (200 parts by weight (resin 84 parts by weight), the colorant particle dispersion liquid (1) (40 parts by weight (pigment 8.6 parts by weight)), the releasing agent particle dispersion liquid (1) (40 parts by weight (releasing agent 8.6 parts by weight)), a latex dispersion of the (A) example compound (A-22) (50 parts by weight (resin content 10 parts by weight), and polyaluminum chloride (0.15 parts by weight) were sufficiently mixed and dispersed in a round flask made of stainless steel, with a homogenizer (trade name: ULTRA-TURRAX T50, manufactured by IKA-Werke GmbH & CO. KG.), and then the mixture was heated to 48° C. while agitating the flask in an oil bath for heating. The mixture was maintained at this temperature for 60 minutes, and then the binding resin microparticle dispersion liquid 3 (68 parts by weight (resin 28.56 parts by weight)) was added thereto under mild stirring.

Fusion Process

Subsequently, the pH in the flask was adjusted to 6.0 using an aqueous solution of sodium hydroxide at a concentration of 0.5 moles/liter, and then the content of the flask was heated to 95° C. while stirring was continued. After the content of the flask had been heated to 95° C., the state was maintained for 4 hours. The pH when the temperature was maintained at 95° C. was about 5.0.

Filtration, Washing and Drying Process

After completion of the reaction, the solution in the flask was cooled and filtered, and thereby a solid fraction was obtained. Subsequently, this solid fraction was sufficiently washed with ion-exchanged water, and then was subjected to solid-liquid separation by Nutsche type suction filtration. Thus, a solid fraction was obtained again.

Next, this solid fraction was redispersed in 3 liters of ion-exchanged water at 40° C., and the dispersion was stirred at 300 rpm for 15 minute and washed. This washing operation was repeated 5 times, and solid-liquid separation was carried out by Nutsche type suction filtration. A solid fraction thus obtained was dried in a vacuum for 12 hours, and thereby particles were obtained. The obtained particles were mixed with 2% of hydrophobic colloidal silica particles (BET value 130 m²/g), and toner particles 26A were obtained. These toner particles 26A had a volume average particle size of 5.9 μm.

6-4. Preparation of Toner Particles 26B

The binder resin microparticle dispersion liquid 3 (200 parts by weight (resin 84 parts by weight)), the colorant particle dispersion liquid (1) (40 parts by weight (pigment 8.6 parts by weight)), the releasing agent particle dispersion liquid (1) (40 parts by weight (releasing agent 8.6 parts by weight)), the (B) example compound (B-22) dispersion liquid (47.6 parts by weight (content of B-22: 10 parts by weight)), and polyaluminum chloride (0.15 parts by weight) were used, and the mixture was subjected to an aggregation process, a fusion process, and a filtration, washing and drying process in exactly the same manner as in the preparation of the toner particles 26A. The mixture was further mixed with hydrophobic colloidal silica particles, and thus toner particles 26B were obtained. These toner particles had a volume average particle size of 6.1 μm.

6-5. Preparation of Developer 26

The toner particles 26A (2.5 parts by weight) and the toner particles 26B (2.5 parts by weight) were mixed with silicon-coated Cu—Zn ferrite carrier particles having an average diameter of 55 μm (95 parts by weight), and thus a developer 26 of Example 22 having a carrier-toner constitution was prepared.

### Example 23

### 7. Preparation of Developer for Electrostatic Photography 27

7-1. Preparation of Toner Particles 27A

The (A) example compound latex dispersion (A-23) (200 parts by weight ((A-23) resin content 80 parts by weight)), the colorant particle dispersion liquid (1) (40 parts by weight (pigment 8.6 parts by weight)), the releasing agent particle dispersion liquid (1) (40 parts by weight (releasing agent 8.6 parts by weight)), and polyaluminum chloride (0.15 parts by weight) were used, and the mixture was subjected to the same aggregation process as in the preparation of the toner particles 26A, as well as the same fusion process, filtration, washing and drying process, and process for mixing with silica particles as in the preparation of the toner particles 26A. Thus, toner particles 27A were obtained.

7-2. Preparation of Toner Particles 27B

Toner particles 27B were prepared in the same manner as in the preparation of the toner particles 26B, except that the (B) example compound (B-23) dispersion liquid prepared in the same manner as in the preparation of the (B-22) dispersion liquid, was used instead of the (B) example compound (B-22) dispersion liquid used for the preparation of the toner particles 26B.

7-3. Preparation of Developer 27

A developer for electrostatic photography 27 of Example 23 was prepared by the same method as that used for the preparation of the developer for electrostatic photography 26, using the toner particles 27A and the toner particles 27B.

### Example 24

### 8. Preparation of Developer for Electrostatic Photography 28

8-1. Preparation of Toner Particles 28A and Toner Particles 28B

Toner particles 28A and toner particles 28B were prepared in the same manner as in the preparation of the toner particles 27A and the toner particles 27B, except that the (A) compound (A-24) and the (B) compound (B-24) were used instead of the (A) example compound (A-23) and the (B) example compound (B-23) used for the preparation of the toner particles 27A.

8-2. Preparation of Developer 28

A developer for electrostatic photography 28 of Example 24 was prepared by the same method as that used for the preparation of the developer 26, using the toner particles 28A and the toner particles 28B.

### Example 25

### 9. Preparation of Developer for Electrostatic Photography 29

9-1. Preparation of Toner Particles 29

A (B) example compound (B-25) dispersion liquid prepared in the same manner as in the preparation of the (B-22) dispersion liquid, was used instead of the (B) example compound (B-22) dispersion liquid used in the preparation of the toner particles 26B, and an aggregation process, a fusion process, and a filtration, washing and drying process were carried out in the same manner as in the preparation of the toner particles 26B. Thus, precursor toner particles were prepared.

These precursor toner particles (93 parts by weight) were mixed with microparticles prepared by freeze-drying the (A) reactive compound latex dispersion (A-25) (5 parts by weight) and hydrophobic colloidal silica particles (BET value 130 m²/g) (2 parts by weight), and thus toner particles 29 were obtained.

9-2. Preparation of Developer for Electrostatic Photography 26

The toner particles 29 (5 parts by weight) were mixed with silicon-coated Cu—Zn ferrite carrier particles having an average diameter of 55 μm (95 parts by weight), and thus a developer for electrostatic photography 29 of Example 25 was prepared.

### Example 26

### 10. Preparation of Developer for Electrostatic Photography 30

10-1. Preparation of Binding Resin Microparticle Dispersion Liquid 4A

A bisphenol A-ethylene oxide 2-mole adduct (30 parts by weight), a bisphenol A-propylene oxide 2-mole adduct (33 parts by weight), terephthalic acid (18.5 parts by weight), dodecenyl succinic acid (14.8 parts by weight), and dibutyltin oxide (0.4 parts by weight) were introduced, and the mixture was stirred for 3.5 hours while water generated therefrom was distilled off at 230° C. A dehydration condensation reaction was continued for 0.5 hours at the same temperature under reduced pressure, and then trimellitic acid (3.3 parts by weight) was introduced therein. The resulting mixture was further reacted for 3 hours at the same temperature under normal pressure, and thus a binding resin was obtained. The binding resin had an acid value of 18 mg KOH/g, a glass transition temperature of 58° C., and a weight average molecular weight of about 30,000.

The obtained binding resin (92 parts by weight), and the (A) reactive compound (A-1) (8 parts by weight) were dissolved in methyl ethyl ketone (75 parts by weight) and isopropyl alcohol (25 parts by weight). While this solution was stirred, a dilute aqueous solution of ammonia was added dropwise thereto in an appropriate amount, and ion-exchanged water was further added dropwise thereto, to achieve phase transfer emulsification. Subsequently, the solvent was eliminated under reduced pressure in an evaporator, and thus a resin particle dispersion liquid was obtained. The volume average particle size of the resin particles of this dispersion liquid was 0.16 μm. The resin particle concentration was adjusted to 30% with ion-exchanged water, and thus binding resin microparticle dispersion liquid 4A was obtained.

10-2. Preparation of Binding Resin Microparticle Dispersion Liquid 4B

Binding resin microparticle dispersion liquid 4B was prepared exactly in the same manner as in the preparation of the binding resin microparticle dispersion liquid 4A, except that the (A) reactive compound (A-1) used for the preparation of the binding resin microparticle dispersion liquid 4A was changed to the (B) reactive compound (B-1).

10-3. Preparation of Toner Particles 30A

The binding resin microparticle dispersion 4A (267 parts by weight (resin 80 parts by weight)), the colorant particle dispersion liquid (1) (40 parts by weight (pigment 8.6 parts by weight)), the releasing agent particle dispersion liquid (1) (40 parts by weight (releasing agent 8.6 parts by weight)), and polyaluminum chloride (0.15 parts by weight) were used, and the mixture was subjected to the same aggregation process as in the preparation of the toner particles 26A, as well as the same fusion process, filtration, washing and drying process, and process for mixing with silica particles as in the preparation of the toner particles 26A. Thus, toner particles 30A were obtained.

10-4. Preparation of Toner Particles 30B

Toner particles 30B were prepared in the same manner as in the preparation of the toner particles 30A, using the binding resin microparticle dispersion liquid 4B instead of the binding resin microparticle dispersion liquid 4A used for the preparation of the toner particles 30A.

10-5. Preparation of Developer 30

A developer for electrostatic photography 30 of Example 26 was prepared by the same method as that used for the preparation of the developer 26, using the toner particles 30A and the toner particles 30B.

Evaluation of Developer

1. Production of Toner Image

The developer for electrostatic photography 5 to the developer for electrostatic photography 30 of Examples 1 to 26, and the developer for electrostatic photography 1 to the developer for electrostatic photography 3 of Comparative Examples 1 to 3 were used to form images on transfer paper using an image forming apparatus (trade name: DOCU CENTRE COLOR 400, manufactured by Fuji Xerox Co., Ltd.). The fixing temperature in this process was 140° C. There were no large differences in terms of the uniformity in image density, glossiness of image, fixability at the time of image formation and the like, and all of the developers showed satisfactory results. It was also proved that low temperature fixability is satisfactory.

2. Confirmation of Occurrence of Reaction by Reactive Compounds

Confirmation about whether the (A) reactive compound A and the (B) reactive compound B according to the invention actually reacted with each other, or not was carried out by measuring infrared absorption spectra of a fixed toner image and an unfixed toner image produced by the method such as described above, and comparing changes in the characteristic absorption caused by the reactive groups. The results are shown in the following Table 2.

3. Confirmation of Three-Dimensionally Bonded Structure Formed as a Result of Reaction of Reactive Compounds

Confirmation about whether the (A) reactive compound A and the (B) reactive compound B according to the invention reacted and formed a three-dimensionally bonded structure in a network form, was carried out by dissolving the fixed toner image produced by the method described above in an organic solvent (tetrahydrofuran), removing the pigment component by centrifugation, and then visually observing if a gel-like component is included in the remaining part as a floating matter. When the developers 5 to 30 of Examples 1 to 26 of the invention were used, generation of a gel-like component was recognized, but in the case of using the developers 1 to 3 of Comparative Examples 1 to 3, generation of a gel-like component was not recognized.

4. Evaluation of Anti-Blocking Property of Image

A solid image in which a reflected cyan density was adjusted to about 1.0 was produced by the method described above. Two sheets of image samples cut to a size of 5 cm×5 cm were prepared, and the image surfaces of these solid images were superimposed to face each other. Weight was placed on the image surfaces so as to apply a load of 80 g/cm2. While in this state, the two sheets of solid images superimposed with the image surfaces facing each other, were left to stand for 24 hours in a thermostatic chamber at 100° C., and then were removed and cooled. The two sheets of beta images superimposed with the image surfaces facing each other were peeled off, and then it was visual observation about whether any image defects occurred upon peeling was conducted. Thus, the blocking property of the images was evaluated on the basis of the following criteria.

O: When the two sheets of images are peeled off, the images are not attaching to each other, and any image defect or change in glossiness is not observed.

O-: When the two sheets of images are peeled off, the images are slightly attaching to each other, but any image defect or change in glossiness is not observed (practically non-problematic level).

X: When the two sheets of images are peeled off, the images are attaching to each other, and destruction of paper or image defect is caused by peeling.

These evaluation results are shown in the following Table 2. All of the developers 5 to 30 for electrostatic photography of Examples 1 to 26 of the invention, which respectively contained the (A) reactive compound A and the (B) reactive compound B according to the invention in a mutually isolated state, did not exhibit any image defects. In contrast, the developers 1 to 3 of the Comparative Examples caused image defects.

5. Evaluation of Toner Caking Property

With respect to evaluation of a toner caking property, 20 g of toner particles prior to the external addition of hydrophobic silica were placed in an aluminum cup, and were stored for 24 hours in a thermostatic chamber maintained at 60° C. Subsequently, the toner particles were taken out, and the occurrence of caking was evaluated.

In a developer formed by mixing two kinds of toner particles, 10 g each of the two kinds of toner microparticles prior to the external addition of hydrophobic silica were thoroughly mixed, and then the mixture was placed in an aluminum cup and was subjected to the evaluation experiment. In the case of the developer 29, the precursor toner particles were mixed only with freeze-dried microparticles of the reactive compound latex (A-25), and then the mixture was placed in an aluminum cup and was subjected to the evaluation. The evaluation was based on the following criteria.

O: Caking of toner does not occur even after the storage, and no change is observed in the toner before and after the storage.

O-: The property is slightly deteriorated as compared with the property of the grade “O”

Δ: Some caking is observed, but the toner is usable for practical use.

X: Complete solidification has occurred, which is problematic in practical use.

The results are shown in the following Table 2. None of the developers 5 to 30 for electrostatic photography of Examples 1 to 26 of the invention and the developer 1 through developer 3 of Comparative Examples 1 to 3 underwent serious solidification.

TABLE 2

| | | Blocking | Toner |
|---|---|---|---|
| | | property of | caking |
| | Developer | image | property |
| Comp. | 1 | X | ◯ |
| Example 1 | | | |
| Comp. | 2 | X | ◯ |
| Example 2 | | | |
| Comp. | 3 | X | Δ |
| Example 3 | | | |
| Reference | 4 | Unable to produce toner | |
| Example | | | |
| Example 1 | 5 | ◯ | ◯ |
| Example 2 | 6 | ◯ | ◯ |
| Example 3 | 7 | ◯ | ◯ |
| Example 4 | 8 | ◯ | ◯ |
| Example 5 | 9 | ◯ | ◯ |
| Example 6 | 10 | ◯ | ◯ |
| Example 7 | 11 | ◯ | ◯ |
| Example 8 | 12 | ◯ | ◯- |
| Example 9 | 13 | ◯- | ◯- |
| Example 10 | 14 | ◯ | ◯- |
| Example 11 | 15 | ◯ | ◯- |
| Example 12 | 16 | ◯ | ◯- |
| Example 13 | 17 | ◯- | ◯ |
| Example 14 | 18 | ◯- | ◯ |
| Example 15 | 19 | ◯- | ◯- |
| Example 16 | 20 | ◯ | ◯ |
| Example 17 | 21 | ◯ | ◯ |
| Example 18 | 22 | ◯ | ◯ |
| Example 19 | 23 | ◯ | ◯ |
| Example 20 | 24 | ◯ | ◯ |
| Example 21 | 25 | ◯ | ◯ |
| Example 22 | 26 | ◯ | ◯ |
| Example 23 | 27 | ◯ | ◯ |
| Example 24 | 28 | ◯ | ◯ |
| Example 25 | 29 | ◯ | Δ |
| Example 26 | 30 | ◯ | ◯ |

From the Table 2 above, it was confirmed that when the developers for electrostatic photography of Examples 1 to 26, each containing polyfunctional reactive compounds that are capable of forming bonds in a three-dimensional network form, in a mutually isolated state, were used, the formed images did not have any defects, and high-strength images were formed due to the presence of the three-dimensionally bonded structure. Thus, it was confirmed that the formed images were excellent in the anti-blocking properties.

On the other hand, in a combination of monofunctional reactive compounds only, or in a combination of bifunctional reactive compounds only, even though the reactive compounds had similar reactive groups, an effective three-dimensionally bonded structure was not formed. Also, a satisfactory effect of enhancing the anti-blocking properties was not obtained, even though the developer was non-problematic in the anti-caking properties of the toner particles prior to image formation. Furthermore, as is apparent from the Reference Example, when two kinds of bifunctional or higher-functional reactive compounds were incorporated without being mutually isolated, an undesired reaction occurred during the preparation of toner particles and resulted in a rigid cured product. Thus, in the Reference Example, practically usable toner particles were not obtained.

All publications, patent applications, and technical standards mentioned in this specification are herein incorporated by reference to the same extent as if each individual publication, patent applications, or technical standards was specifically and individually indicated to be incorporated by reference.

What is claimed is:

1. A toner composition for electrostatic photography, comprising a reactive compound A having a reactive group XA, and a reactive compound B having a reactive group XB that is capable of reacting with the reactive group XA and forming a bond, wherein the reactive compound B is capable of forming a three-dimensionally bonded structure by reacting with the reactive compound A, and wherein the toner composition comprises the reactive compound A and the reactive compound B in a mutually isolated state.

2. The toner composition for electrostatic photography according to claim 1, comprising first toner particles comprising the reactive compound A and second toner particles comprising the reactive compound B.

3. The toner composition for electrostatic photography according to claim 1, comprising toner particles comprising one of the reactive compound A or the reactive compound B, and external additive particles comprising the other of the reactive compound A or the reactive compound B that is not present in the toner particles, in a state in which the external additive particles are attached to the surface of the toner particles.

4. The toner composition for electrostatic photography according to claim 1, wherein when the number of the reactive group XA included in the reactive compound A is designated as nA, and the number of reaction sites carried by the reactive group XA is designated as mA, and when the number of the reactive group XB included in the reactive compound B is designated as nB, and the number of reaction sites carried by the reactive group XB is designated as mB, nA, mA, nB and mB satisfy relationships represented by the following expressions:
(nA×mA)≧2,
(nB×mB)≧2, and
{at least one of (nA×mA) or (nB×mB)}≧3.

5. The toner composition for electrostatic photography according to claim 1, wherein the reactive group XA is a nucleophilic group, and the reactive group XB is an electrophilic group.

6. A developer for electrostatic photography, comprising the toner composition for electrostatic photography according to claim 1.

7. A method of forming an electrostatic photographic image, comprising:
exposing a surface of a latent image carrier which is charged and thereby forming an electrostatic latent image;
attaching the developer for electrostatic photography according to claim 6 to the electrostatic latent image and thereby forming an image; and
fixing the formed image to a recording medium by heating.

8. An electrostatic photographic image, produced by using the developer for electrostatic photography according to claim 6.
